(19) United States
(12) Patent Application Publication
(10) Pub. No.: US 2016/0303432 A1
(43) Pub. Date: Oct. 20, 2016

(54) GOLF BALL WITH POLYALKENAMER BLEND

(71) Applicant: Taylor Made Golf Company, Inc., Carlsbad, CA (US)

(72) Inventor: Hong G. Jeon, Carlsbad, CA (US)

(73) Assignee: Taylor Made Golf Company, Inc., Carlsbad, CA (US)

(21) Appl. No.: 15/098,239

(22) Filed: Apr. 13, 2016

Related U.S. Application Data
(60) Provisional application No. 62/147,496, filed on Apr. 14, 2015.

(51) Int. Cl. A63B 37/00; C08L 65/00

(52) U.S. Cl. CPC A63B 37/0092; C08L 65/00; A63B 37/004; A63B 37/005; A63B 37/0023; C08L 2312/00

(57) ABSTRACT

A golf ball comprising:
(a) a core;
(b) one or more mantle layers; and
(c) an outer cover layer, wherein
at least one of the mantle layers comprises a blend composition of a lithium-catalyzed polybutadiene rubber and a polyalkenamer.

This application claims the benefit of U.S. Provisional Application No. 62/147,496, filed Apr. 14, 2015, which is incorporated herein by reference in its entirety.

### BACKGROUND

The present invention relates to golf balls comprising a particular composition suitable for use in golf ball manufacture. In one embodiment, the present invention is used in the manufacture of a golf ball comprising a core, a cover layer and, one or more mantle layers. In one preferred embodiment, a golf ball is disclosed in which at least one mantle layer comprises the novel composition of the present invention.

### SUMMARY

Disclosed herein is a golf ball comprising:
(a) a core;
(b) one or more mantle layers; and
(c) an outer cover layer, wherein
at least one of the mantle layers comprises a blend composition of a lithium-catalyzed polybutadiene rubber and a polyalkenamer.

The foregoing will become more apparent from the following detailed description, which proceeds with reference to the accompanying figures.

### BRIEF DESCRIPTION OF THE DRAWINGS

FIG. 1 illustrates a three-piece golf ball 1 comprising a solid center or core 2, an intermediate layer 3, and an outer cover layer 4.

FIG. 2 illustrates a four-piece golf ball 1 comprising a core 2, and an outer cover layer 5, an inner intermediate layer 3, and an outer intermediate layer 4.

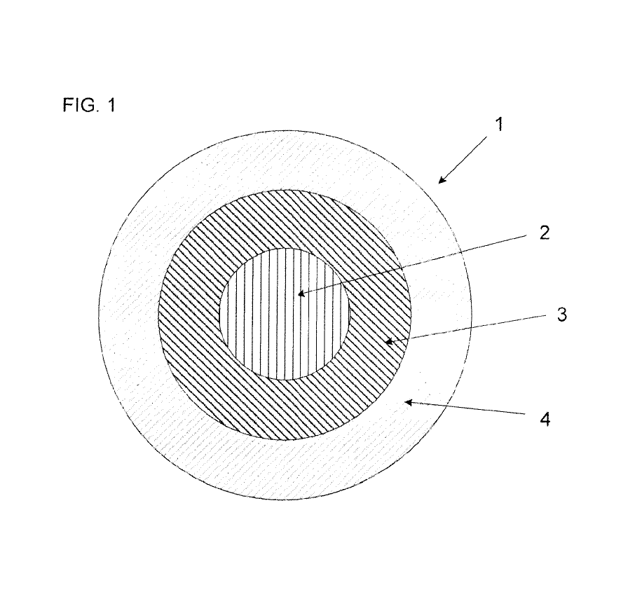

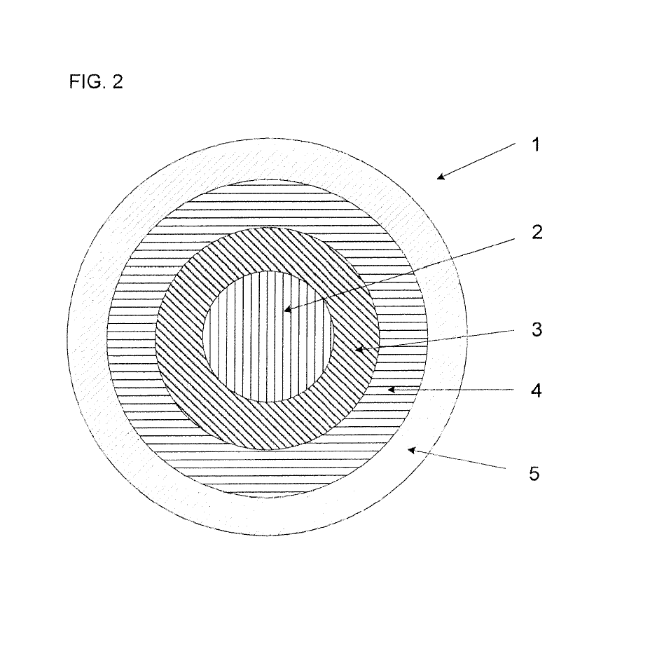

Although FIGS. 1 and 2 illustrate only three- and four-piece golf ball constructions, golf balls of the present invention may comprise from 1 to at least 5 intermediate layer(s), preferably from 1 to 3 intermediate layer(s), more preferably from 1 to 2 intermediate layer(s).

### DETAILED DESCRIPTION

Any numerical values recited herein include all values from the lower value to the upper value in increments of one unit provided that there is a separation of at least 2 units between any lower value and any higher value. As an example, if it is stated that the amount of a component or a value of a process variable is from 1 to 90, preferably from 20 to 80, more preferably from 30 to 70, it is intended that values such as 15 to 85, 22 to 68, 43 to 51, 30 to 32 etc. are expressly enumerated in this specification. For values, which have less than one unit difference, one unit is considered to be 0.1, 0.01, 0.001, or 0.0001 as appropriate. Thus all possible combinations of numerical values between the lowest value and the highest value enumerated herein are said to be expressly stated in this application.

The term “bimodal polymer” refers to a polymer comprising two main fractions and more specifically to the form of the polymers molecular weight distribution curve, i.e., the appearance of the graph of the polymer weight fraction as function of its molecular weight. When the molecular weight distribution curves from these fractions are superimposed into the molecular weight distribution curve for the total resulting polymer product, that curve will show two maxima or at least be distinctly broadened in comparison with the curves for the individual fractions. Such a polymer HACE product is called bimodal. It is to be noted here that also the chemical compositions of the two fractions may be different.

As used herein, the term “block copolymer” is intended to mean a polymer comprising two or more homopolymer subunits linked by covalent bonds. The union of the homopolymer subunits may require an intermediate non-repeating subunit, known as a junction block. Block copolymers with two or three distinct blocks are called diblock copolymers and triblock copolymers, respectively.

The term “core” is intended to mean the elastic center of a golf ball. The core may be a unitary core having a center it may have one or more “core layers” of elastic material, which are usually made of rubbery material such as diene rubbers.

The term “cover layer” is intended to mean the outermost layer of the golf ball; this is the layer that is directly in contact with paint and/or ink on the surface of the golf ball. If the cover consists of two or more layers, only the outermost layer is designated the cover layer, and the remaining layers (excluding the outermost layer) are commonly designated intermediate layers as herein defined. The term “outer cover layer” as used herein is used interchangeably with the term “cover layer.”

The term “fiber” as used herein is a general term for which the definition given in Engineered Materials Handbook, Vol. 2, “Engineering Plastics”, published by A.S.M. International, Metals Park, Ohio, USA, is relied upon to refer to filamentary materials with a finite length that is at least 100 times its diameter, which is typically 0.10 to 0.13 mm (0.004 to 0.005 in.). Fibers can be continuous or specific short lengths (discontinuous), normally no less than 3.2 mm (⅛ in.). Although fibers according to this definition are preferred, fiber segments, i.e., parts of fibers having lengths less than the aforementioned are also considered to be encompassed by the invention. Thus, the terms “fibers” and “fiber segments” are used herein. In the claims appearing at the end of this disclosure in particular, the expression “fibers or fiber segments” and “fiber elements” are used to encompass both fibers and fiber segments.

The term “hydrocarbyl” is intended to mean any aliphatic, cycloaliphatic, aromatic, aryl substituted aliphatic, aryl substituted cycloaliphatic, aliphatic substituted aromatic, or cycloaliphatic substituted aromatic groups. The aliphatic or cycloaliphatic groups are preferably saturated. Likewise, the term “hydrocarbyloxy” means a hydrocarbyl group having an oxygen linkage between it and the carbon atom to which it is attached.

The term “carboxy group” is intended to mean any group containing a carbon atom that is linked by a double bond to one oxygen atom and by one single bond to another carbon atom and by another single bond to an oxygen, nitrogen, sulfur, or another carboxy carbon. One suitable carboxy group contained in the carboxylated elastomers used in the present invention may be represented by the general formula —COOR, wherein R may be a hydrogen, a metal (for example, an alkali metal, an alkaline earth metal, or a transition metal), an ammonium or a quaternary ammonium group, an acyl group (for example acetyl (CH₃C(O)) group), an alkyl group (such as an ester), an acid anhydride group, and combinations thereof. Examples of suitable carboxy groups include, but are not limited to, carboxylic acid, carboxy esters, carboxy acid anhydrides, and monovalent, divalent and trivalent metal salts of carboxy acids, derivatives thereof and any and combinations thereof.

The term “mantle layer” may be used interchangeably herein with the terms “intermediate layer” and is intended to mean any layer(s) in a golf ball disposed between the core and the outer cover layer. Should a ball have more than one mantle layer, these may be distinguished as “inner intermediate layer” or “inner mantle layer” which terms may be used interchangeably to refer to the intermediate layer nearest the core and furthest from the outer cover, as opposed to the “outer intermediate layer” or “outer mantle layer” which terms may also used interchangeably to refer to the intermediate layer furthest from the core and closest to the outer cover, and if there are three intermediate layers, these may be distinguished as “inner intermediate layer” or “inner mantle layer” which terms are used interchangeably to refer to the intermediate or mantle layer nearest the core and furthest from the outer cover, as opposed to the “outer intermediate layer” or “outer mantle layer” which terms are also used interchangeably to refer to the intermediate layer further from the core and closer to the outer cover, and as opposed to the “intermediate layer” or “intermediate mantle layer” which terms are also used interchangeably to refer to the intermediate layer between the inner intermediate layer and the outer intermediate layer.

The term “(meth)acrylic acid copolymers” is intended to mean copolymers of methacrylic acid and/or acrylic acid.

The term “(meth)acrylate” is intended to mean an ester of methacrylic acid and/or acrylic acid.

The term “partially neutralized” is intended to mean an ionomer with a degree of neutralization of less than 100 percent. The term “highly neutralized” is intended to mean an ionomer with a degree of neutralization of greater than 50 percent. The term “fully neutralized” is intended to mean an ionomer with a degree of neutralization of 100 percent.

The term “prepolymer” as used herein is intended to mean any polymeric material that can be further processed to form a final polymer material of a manufactured golf ball, such as, by way of example and not limitation, a polymerized or partially polymerized material that can undergo additional processing, such as crosslinking.

The term “thermoplastic” as used herein is intended to mean a material that is capable of softening or melting when heated and of hardening again when cooled. Thermoplastic polymer chains often are not cross-linked or are lightly crosslinked using a chain extender, but the term “thermoplastic” as used herein may refer to materials that initially act as thermoplastics, such as during an initial extrusion process or injection molding process, but which also may be crosslinked, such as during a compression molding step to form a final structure.

The term “thermoset” as used herein is intended to mean a material that crosslinks or cures via interaction with as crosslinking or curing agent. Crosslinking may be induced by energy, such as heat (generally above 200° C.), through a chemical reaction (by reaction with a curing agent), or by irradiation. The resulting composition remains rigid when set, and does not soften with heating. Thermosets have this property because the long-chain polymer molecules cross-link with each other to give a rigid structure. A thermoset material cannot be melted and re-molded after it is cured. Thus thermosets do not lend themselves to recycling unlike thermoplastics, which can be melted and re-molded.

The term “thermoplastic polyurethane” as used herein is intended to mean a material prepared by reaction of a prepared by reaction of a diisocyanate with a polyol, and optionally addition of a chain extender.

The term “thermoplastic polyurea” as used herein is intended to mean a material prepared by reaction of a prepared by reaction of a diisocyanate with a polyamine, with optionally addition of a chain extender.

The term “thermoset polyurethane” as used herein is intended to mean a material prepared by reaction of a diisocyanate with a polyol (or a prepolymer of the two), and a curing agent.

The term “thermoset polyurea” as used herein is intended to mean a material prepared by reaction of a diisocyanate with a polyamine (or a prepolymer of the two) and a curing agent.

The term “unimodal polymer” refers to a polymer comprising one main fraction and more specifically to the form of the polymers molecular weight distribution curve, i.e., the molecular weight distribution curve for the total polymer HACE product shows only a single maximum.

The term “urethane prepolymer” as used herein is intended to mean the reaction HACE product of diisocyanate and a polyol.

The term “urea prepolymer” as used herein is intended to mean the reaction product of a diisocyanate and a polyamine.

The term “zwitterion” as used herein is intended to mean a form of the compound having both an amine group and carboxylic acid group, where both are charged and where the net charge on the compound is neutral.

The present invention can be used in forming golf balls of any desired size. “The Rules of Golf” by the USGA dictate that the size of a competition golf ball must be at least 1.680 inches in diameter; however, golf balls of any size can be used for leisure golf play. The preferred diameter of the golf balls is from about 1.680 inches to about 1.800 inches. The more preferred diameter is from about 1.680 inches to about 1.760 inches. A diameter of from about 1.680 inches to about 1.740 inches is most preferred; however diameters anywhere in the range of from 1.70 to about 2.0 inches can be used. Oversize golf balls with diameters above about 1.760 inches to as big as 2.75 inches are also within the scope of the invention.

Disclosed herein is a blend of a lithium-catalyzed polybutadiene rubber and a polyalkenamer. As used herein, a “blend” or “blend composition” can be a physical mixture of components A and B and/or a reaction product produced by a reaction between components A and B. When used in golf ball mantles, these materials exhibit improved impact durability when compared to golf balls that do not include a lithium-catalyzed polybutadiene rubber. Furthermore, in certain embodiments utilization of these materials in a mantle layer enables the use of thinner cover layers.

### Li-Catalyzed Polybutadiene Rubber

In general, 1, 3-butadiene can be polymerized to yield cis, trans and vinyl polymers as shown in the composite below.

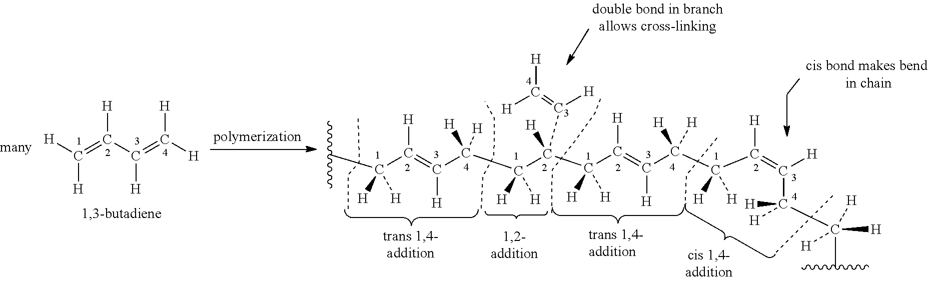

The properties of the resulting isomeric forms of polybutadiene differ as they can result from cis and trans linkages (both resulting from 1, 4-addition) as well as linkages resulting from 1, 2-addition which results in vinyl group side chains in the polymer. For example, “high cis” polybutadiene is characterized by a high proportion of cis linkages (typically over 92%) and a small proportion of vinyl groups (less than 4%). It typically has high elasticity and thus is often used in typical golf ball core formulations. So-called “low cis” polybutadiene typically contains about 35% cis, 55% trans and 10% vinyl and has a high liquid-glass transition, and can be advantageously used as an additive in plastics due to its low contents of gels. So-called “high trans” polybutadiene is a crystalline polymer (i.e. not an elastomer) which melts at about 80° C. and has been used for golf ball cover layers, due to its similarity in structure to polyisoprene balata rubber. “High-vinyl” polybutadiene typically has over 70% vinyl content resulting from a 1, 2-addition mechanism. In addition to these kinds of connectivity, polybutadienes can also differ in terms of their branching their molecular weights and molecular weight distributions.

The Li-catalyzed polybutadiene for use in the golf ball of the present invention may contain from 20 to 70, preferably from 30 to 65, and more preferably from 40 to 55 mol percent trans 1,4-addition. The Li-catalyzed polybutadiene for use in the golf ball of the present invention may contain from 20 to 50, preferably from 25 to 45, and more preferably from 30 to 40 mol percent cis 1,4-addition. The Li-catalyzed polybutadiene for use in the golf ball of the present invention may contain from 3 to 40, preferably from 7 to 30, and more preferably from 10 to 20 mol percent 1,2-vinyl content. These polymers are prepared by polymerizing butadiene in a suitable solvent (which does not adversely affect the polymerization, for example, a hydrocarbon solvent), in the presence of a lithium (e.g., hydrocarbyllithium) catalyst.

The Mooney Viscosity (ML₁₊₄, 100° C.) of the Li-catalyzed polybutadiene is in the range of 30 to 80, preferably 35 to 7-, even more preferably 40 to 60.

The lithium-based catalysts employed for the polymerization of 1, 3-butadiene may comprise metallic lithium, organolithium compounds, or other compounds of lithium in which lithium can displace hydrogen from water. Organolithium compounds, as used herein, include the various hydrocarbyllithiums, i.e., hydrocarbons in which one or more hydrogen atoms have been replaced by lithium, and adducts of lithium with polycyclic aromatic compounds. Suitable hydrocarbyllithiums include, for instance, alkyllithium compounds, such as methyllithium, ethyllithium, butyllithium, amyllithium, hexyllithium, 2-ethylhexyllithium and n-hexyldecyllithium.

The concentration of the lithium catalyst employed can vary widely depending on the particular catalyst employed, reaction conditions, the product desired, etc. For example, concentrations of catalyst, based on solvent and actual weight of lithium in the catalyst, can vary from about 0.001 to about 10 percent or greater.

Lewis bases which can be employed include ethers, thioethers, tertiary amines and the like, in concentrations of about 0.5 to about 20 percent, based on solvent. The actual concentration of the Lewis base will depend upon the particular Lewis base used and the polymer desired.

The organic ethers that are employed include alkyl, aryl, aralkyl, alkaryl and cyclic ethers such as dioxane and tetrahydrofuran. Ethers of glycols may also be employed, for example, the dimethyl ether of diethylene glycol. The corresponding thioethers and tertiary amines can also be employed.

Aromatic, aliphatic and alicyclic hydrocarbon solvents can be employed. Alicyclic solvents include cyclohexane. Aliphatic solvents include heptane, pentane, butane, hexane and the like. Aromatic solvents include benzene, toluene and xylenes.

Polymerization temperatures in the range of 10°−100° C. can be used. Pressures of atmospheric to ten or twenty atmospheres are employed so as to maintain a high concentration of the reactant in the liquid phase. The concentration of the butadiene in the solvent can vary widely such as from 5 to 75 percent.

The polymerization is carried out in an inert atmosphere, in the absence of air, carbon dioxide, oxygen and the like. It can be carried out under an atmosphere of an inert gas such as pure nitrogen, helium, argon, etc., in vacuum, or under a pressure of inert organic materials.

In certain embodiments, the Li-catalyzed polybutadiene is not injection moldable. In certain embodiments, the double bonds in the Li-catalyzed polybutadiene are not hydrogenated.

The Li-catalyzed polybutadiene is not crosslinked prior to blending with polyalkenamer.

### Polyalkenamer

The term “polyalkenamer” is used interchangeably herein with the term “polyalkenamer rubber” and means a rubbery polymer of one or more cycloalkenes having from 4-20, ring carbon atoms. The polyalkenamers may be prepared by ring opening metathesis polymerization of one or more cycloalkenes in the presence of organometallic catalysts as described in U.S. Pat. Nos. 3,492,245, and 3,804,803, the entire contents of both of which are herein incorporated by reference.

Examples of suitable polyalkenamer rubbers are polybutenamer rubber, polypentenamer rubber, polyhexenamer rubber, polyheptenamer rubber, polyoctenamer rubber, polynonenamer rubber, polydecenamer rubber polyundecenamer rubber, polydodecenamer rubber, polytridecenamer rubber. For further details concerning polyalkenamer rubber, see Rubber Chem. & Tech., Vol. 47, page 511-596, 1974, which is incorporated herein by reference. Polyoctenamer rubbers are commercially available from Huls AG of Marl, Germany, and through its distributor in the U.S., Creanova Inc. of Somerset, N.J., and sold under the trademark VESTENAMER®. Two grades of the VESTENAMER® trans-polyoctenamer are commercially available: VESTENAMER 8012 designates a material having a trans-content of approximately 80% (and a cis-content of 20%) with a melting point of approximately 54° C.; and VESTENAMER 6213 designates a material having a trans-content of approximately 60% (cis-content of 40%) with a melting point of approximately 30° C. Both of these polymers have a double bond at every eighth carbon atom in the ring.

The polyalkenamer rubbers used in the present disclosure exhibit excellent melt processability above their sharp melting temperatures and exhibit high miscibility with various rubber additives as a major component without deterioration of crystallinity which in turn facilitates injection molding. Thus, unlike synthetic polybutadiene rubbers typically used in golf ball core preparation, injection molded parts of polyalkenamer-based compounds can be prepared which, in addition, can also be partially or fully crosslinked at elevated temperature. The crosslinked polyalkenamer compounds are highly elastic, and their mechanical and physical properties can be easily modified by adjusting the formulation.

The polyalkenamer rubber preferably contains from about 50 to about 99, preferably from about 60 to about 99, more preferably from about 65 to about 99, even more preferably from about 70 to about 90 percent of its double bonds in the trans-configuration. The preferred form of the polyalkenamer has a trans content of approximately 80%, however, compounds having other ratios of the cis- and trans-isomeric forms of the polyalkenamer can also be obtained by blending available products for use in making the composition.

The polyalkenamer rubber has a molecular weight (as measured by GPC) from about 10,000 to about 300,000, preferably from about 20,000 to about 250,000, more preferably from about 30,000 to about 200,000, even more preferably from about 50,000 to about 150,000.

The polyalkenamer rubber has a degree of crystallization (as measured by DSC secondary fusion) from about 5 to about 70, preferably from about 6 to about 50, more preferably from about from 6.5 to about 50%, even more preferably from about from 7 to about 45%,

More preferably, the polyalkenamer rubber is a polymer prepared by polymerization of cyclooctene to form a trans-polyoctenamer rubber as a mixture of linear and cyclic macromolecules.

The polyalkenamer is not crosslinked prior to blending with the Li-catalyzed polybutadiene rubber.

### Li-Catalyzed Polybutadiene/Polyalkenamer Blend

In certain embodiments, the Li-catalyzed polybutadiene may be present in the blend in an amount of 2 to 50 weight %, more preferably 5 to 35 weight %, and most preferably 10 to 25 weight %, based on the total weight of the Li-catalyzed polybutadiene combined with the polyalkenamer. In certain embodiments, the polyalkenamer may be present in the blend in an amount of 50 to 98 weight %, more preferably 65 to 95 weight %, and most preferably 75 to 90 weight %, based on the total weight of the Li-catalyzed polybutadiene combined with the polyalkenamer.

In certain embodiments, the Li-catalyzed polybutadiene/polyalkenamer blend constitutes the majority component of a mantle layer. In particular, the Li-catalyzed polybutadiene/polyalkenamer blend (including crosslinking agents, co-crosslinking agents, peptizers and/or accelerators, if present), constitutes greater than 40 weight %, more preferably greater than 45 weight %, and most preferably greater than 50 weight %, of the total weight of the composition forming the mantle layer.

Prior to its use in golf balls, the Li-catalyzed polybutadiene/polyalkenamer rubber blend may be further formulated with one or more of the following blend components:

### A. Crosslinking Agents

The synthetic rubber compositions used in the present invention may include any crosslinking or curing system typically used for rubber crosslinking Satisfactory crosslinking systems may include those based on sulfur-, peroxide-, azide-, maleimide- or resin-vulcanization agents, which may be used in conjunction with a vulcanization accelerator. Examples of satisfactory crosslinking system components are zinc oxide, sulfur, organic peroxide, azo compounds, magnesium oxide, benzothiazole sulfenamide accelerator, benzothiazyl disulfide, phenolic curing resin, m-phenylene bis-maleimide, thiuram disulfide and dipentamethylene-thiuram hexasulfide.

More preferable crosslinking agents include peroxides, sulfur compounds, as well as mixtures of these. Non-limiting examples of suitable crosslinking agents include primary, secondary, or tertiary aliphatic or aromatic organic peroxides. Peroxides containing more than one peroxy group can be used, such as 2,5-dimethyl-2,5-di(tert-butylperoxy)hexane and 1,4-di-(2-tert-butyl peroxyisopropyl)benzene. Both symmetrical and asymmetrical peroxides can be used, for example, tert-butyl perbenzoate and tert-butyl cumyl peroxide. Peroxides incorporating carboxyl groups also are suitable. The decomposition of peroxides used as crosslinking agents in the disclosed compositions can be brought about by applying thermal energy, shear, irradiation, reaction with other chemicals, or any combination of these. Both homolytically and heterolytically decomposed peroxide can be used. Non-limiting examples of suitable peroxides include: diacetyl peroxide; di-tert-butyl peroxide; dibenzoyl peroxide; dicumyl peroxide; 2,5-dimethyl-2,5-di(benzoylperoxy)hexane; 1,4-bis-(t-butylperoxyisopropyl)benzene; t-butylperoxybenzoate; 2,5-dimethyl-2,5-di-(t-butylperoxy)hexyne-3, such as Trigonox 145-45B, marketed by Akrochem Corp. of Akron, Ohio; 1,1-bis(t-butylperoxy)-3,3,5 tri-methylcyclohexane, such as Varox 231-XL, marketed by R.T. Vanderbilt Co., Inc. of Norwalk, Conn.; and di-(2,4-dichlorobenzoyl)peroxide.

The crosslinking agents can be blended in total amounts of about 0.1 part to about 10, more preferably about 0.4 to about 6, and most preferably about 0.8 part to about 4 parts per 100 parts of the synthetic rubber compositions used in the present invention. The crosslinking agent(s) may be mixed directly into or with the synthetic rubber compositions, or the crosslinking agent(s) may be pre-mixed with the synthetic rubber component to form a concentrated compound prior to subsequent compounding with the bulk of the synthetic rubber compositions used in the present invention.

Each peroxide crosslinking agent has a characteristic decomposition temperature at which 50% of the crosslinking agent has decomposed when subjected to that temperature for a specified time period (t_{1/2}). For example, 1,1-bis-(t-butylperoxy)-3,3,5-tri-methylcyclohexane at t_{1/2}=0.1 hr has a decomposition temperature of 138° C. and 2,5-dimethyl-2,5-di-(t-butylperoxy)hexyne-3 at t_{1/2}=0.1 hr has a decomposition temperature of 182° C. Two or more crosslinking agents having different characteristic decomposition temperatures at the same t_{1/2} may be blended in the composition. For example, where at least one crosslinking agent has a first characteristic decomposition temperature less than 150° C., and at least one crosslinking agent has a second characteristic decomposition temperature greater than 150° C., the composition weight ratio of the at least one crosslinking agent having the first characteristic decomposition temperature to the at least one crosslinking agent having the second characteristic decomposition temperature can range from 5:95 to 95:5, or more preferably from 10:90 to 50:50.

Besides the use of chemical crosslinking agents, exposure of the synthetic rubber compositions used in the present invention to radiation also can serve as a crosslinking agent. Radiation can be applied to the synthetic rubber compositions by any known method, including using microwave or gamma radiation, or an electron beam device. Additives may also be used to improve radiation-induced crosslinking of the synthetic rubber composition.

### B. Co-Crosslinking Agent

The synthetic rubber compositions used in the present invention may also be blended with a co-crosslinking agent, which may be an unsaturated carboxylic acid, or a metal salt thereof. Examples of these include zinc and magnesium salts of unsaturated fatty acids having 3 to 8 carbon atoms, such as acrylic acid, methacrylic acid, maleic acid, and fumaric acid, palmitic acid with the zinc salts of acrylic and methacrylic acid being most preferred. The unsaturated carboxylic acid metal salt can be blended in the synthetic rubber compositions either as a preformed metal salt, or by introducing an α,β-unsaturated carboxylic acid and a metal oxide or hydroxide into the synthetic rubber composition, and allowing them to react to form the metal salt. The unsaturated carboxylic acid metal salt can be blended in any desired amount, but preferably in amounts of about 5 to about 160, more preferably from about 10 to about 150, most preferably from about 20 to about 140 parts per 100 parts of the synthetic rubber composition.

### C. Peptizer

The synthetic rubber compositions used in the present invention may also incorporate one or more of the so-called “peptizers”. The peptizer preferably comprises an organic sulfur compound and/or its metal or non-metal salt. Examples of such organic sulfur compounds include thiophenols, such as pentachlorothiophenol, 4-butyl-o-thiocresol, 4 t-butyl-p-thiocresol, and 2-benzamidothiophenol; thiocarboxylic acids, such as thiobenzoic acid; 4,4′ dithio dimorpholine; and, sulfides, such as dixylyl disulfide, dibenzoyl disulfide; dibenzothiazyl disulfide; di(pentachlorophenyl) disulfide; dibenzamido diphenyldisulfide (DBDD), and alkylated phenol sulfides, such as VULTAC marketed by Atofina Chemicals, Inc. of Philadelphia, Pa. Preferred organic sulfur compounds include pentachlorothiophenol, and dibenzamido diphenyldisulfide.

Examples of the metal salt of an organic sulfur compound include sodium, potassium, lithium, magnesium calcium, barium, cesium and zinc salts of the above-mentioned thiophenols and thiocarboxylic acids, with the zinc salt of pentachlorothiophenol being most preferred. Examples of the non-metal salt of an organic sulfur compound include ammonium salts of the above-mentioned thiophenols and thiocarboxylic acids wherein the ammonium cation has the general formula [NR¹R²R³R⁴]⁺ where R¹, R², R³ and R⁴ are selected from the group consisting of hydrogen, a C₁-C₂₀ aliphatic, cycloaliphatic or aromatic moiety, and any and all combinations thereof, with the most preferred being the NH₄⁺-salt of pentachlorothiophenol.

Additional peptizers include aromatic or conjugated peptizers comprising one or more heteroatoms, such as nitrogen, oxygen and/or sulfur. More typically, such peptizers are heteroaryl or heterocyclic compounds having at least one heteroatom, and potentially plural heteroatoms, where the plural heteroatoms may be the same or different. Such peptizers include peptizers such as an indole peptizer, a quinoline peptizer, an isoquinoline peptizer, a pyridine peptizer, purine peptizer, a pyrimidine peptizer, a diazine peptizer, a pyrazine peptizer, a triazine peptizer, a carbazole peptizer, or combinations of such peptizers.

Suitable peptizers also may include one or more additional functional groups, such as halogens, particularly chlorine; a sulfur-containing moiety exemplified by thiols, where the functional group is sulfhydryl (—SH), thioethers, where the functional group is —SR, disulfides, (R₁S—SR₂), etc.; and combinations of functional groups. Such peptizers are more fully disclosed in copending U.S. Application No. 60/752,475 filed on Dec. 20, 2005 in the name of Hyun Kim et al, the entire contents of which are herein incorporated by reference. A most preferred example is 2,3,5,6-tetrachloro-4-pyridinethiol (TCPT).

The peptizer, if employed in the synthetic rubber formulations used to prepare the golf balls of the present invention, is present in an amount up to about 10, from about 0.1 to about 10, preferably of from about 0.5 to about 8, more preferably of from about 1 to about 6 parts by weight per 100 parts by weight of the synthetic rubber component.

### D. Accelerators

The synthetic rubber compositions used in the present invention can also comprise one or more accelerators of one or more classes. Accelerators are added to an unsaturated polymer to increase the vulcanization rate and/or decrease the vulcanization temperature. Accelerators can be of any class known for rubber processing including mercapto-, sulfenamide-, thiuram, dithiocarbamate, dithiocarbamyl-sulfenamide, xanthate, guanidine, amine, thiourea, and dithiophosphate accelerators. Specific commercial accelerators include 2-mercaptobenzothiazole and its metal or non-metal salts, such as Vulkacit Mercapto C, Mercapto MGC, Mercapto ZM-5, and ZM marketed by Bayer AG of Leverkusen, Germany, Nocceler M, Nocceler MZ, and Nocceler M-60 marketed by Ouchisinko Chemical Industrial Company, Ltd. of Tokyo, Japan, and MBT and ZMBT marketed by Akrochem Corporation of Akron, Ohio. A more complete list of commercially available accelerators is given in The Vanderbilt Rubber Handbook: 13^{th} Edition (1990, R.T. Vanderbilt Co.), pp. 296-330, in Encyclopedia of Polymer Science and Technology, Vol. 12 (1970, John Wiley & Sons), pp. 258-259, and in Rubber Technology Handbook (1980, Hanser/Gardner Publications), pp. 234-236. Preferred accelerators include 2-mercaptobenzothiazole (MBT) and its salts.

The synthetic rubber composition can further incorporate from about 0.1 part to about 10 parts by weight of the accelerator per 100 parts by weight of the synthetic rubber. More preferably, the ball composition can further incorporate from about 0.5 part to about 8 parts, and most preferably from about 1 part to about 6 parts, by weight of the accelerator per 100 parts by weight of the synthetic rubber.

### Additional Polymer Components

Additional polymers may also be used as a separate component of the core, cover layer or mantle layer of the golf balls of the present invention. These additional polymers may include, without limitation, other synthetic and natural rubbers, including the polyalkenamers, cis-1,4-polybutadiene, trans-1,4-polybutadiene, 1,2-polybutadiene, cis-polyisoprene, trans-polyisoprene, polychloroprene, polybutylene, styrene-butadiene rubber, styrene-butadiene-styrene block copolymer and partially and fully hydrogenated equivalents, styrene-isoprene-styrene block copolymer and partially and fully hydrogenated equivalents, nitrile rubber, silicone rubber, and polyurethane, as well as mixtures of these, carboxyl-terminated butadiene (CTBN) and butadiene grafted with maleic anhydride (BMA), thermoset polymers such as thermoset polyurethanes and thermoset polyureas, as well as thermoplastic polymers including thermoplastic elastomers such as unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyesters, copolyesters, polyamides, copolyamides, polycarbonates, polyolefins, polyphenylene oxide, polyphenylene sulfide, diallyl phthalate polymer, polyimides, polyvinyl chloride, polyamide-ionomer, polyurethane-ionomer, polyvinyl alcohol, polyarylate, polyacrylate, polyphenylene ether, impact-modified polyphenylene ether, polystyrene, high impact polystyrene, acrylonitrile-butadiene-styrene copolymer styrene-acrylonitrile (SAN), acrylonitrile-styrene-acrylonitrile, styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, and polysiloxane and any and all combinations thereof.

The olefinic thermoplastic elastomers include metallocene-catalyzed polyolefins, ethylene-octene copolymer, ethylene-butene copolymer, and ethylene-propylene copolymers all with or without controlled tacticity as well as blends of polyolefins having ethyl-propylene-non-conjugated diene terpolymer, rubber-based copolymer, and dynamically vulcanized rubber-based copolymer. Examples of these include products sold under the trade names SANTOPRENE, DYTRON, VISAFLEX, and VYRAM by Advanced Elastomeric Systems of Houston, Tex., and SARLINK by DSM of Haarlen, the Netherlands.

Examples of rubber-based thermoplastic elastomers include multiblock rubber-based copolymers, particularly those in which the rubber block component is based on butadiene, isoprene, or ethylene/butylene. The non-rubber repeating units of the copolymer may be derived from any suitable monomers, including meth(acrylate) esters, such as methyl methacrylate and cyclohexylmethacrylate, and vinyl arylenes, such as styrene. Examples of styrenic copolymers are resins manufactured by Kraton Polymers (formerly of Shell Chemicals) under the trade names KRATON D (for styrene-butadiene-styrene and styrene-isoprene-styrene types) and KRATON G (for styrene-ethylene-butylene-styrene and styrene-ethylene-propylene-styrene types) and Kuraray under the trade name SEPTON. Examples of randomly distributed styrenic polymers include paramethylstyrene-isobutylene (isobutene) copolymers developed by ExxonMobil Chemical Corporation and styrene-butadiene random copolymers developed by Chevron Phillips Chemical Corp.

Further polymers include copolyester thermoplastic elastomers which include polyether ester block copolymers, polylactone ester block copolymers, and aliphatic and aromatic dicarboxylic acid copolymerized polyesters. Polyether ester block copolymers are copolymers comprising polyester hard segments polymerized from a dicarboxylic acid and a low molecular weight diol, and polyether soft segments polymerized from an alkylene glycol having 2 to 10 atoms. Polylactone ester block copolymers are copolymers having polylactone chains instead of polyether as the soft segments discussed above for polyether ester block copolymers. Aliphatic and aromatic dicarboxylic copolymerized polyesters are copolymers of an acid component selected from aromatic dicarboxylic acids, such as terephthalic acid and isophthalic acid, and aliphatic acids having 2 to 10 carbon atoms with at least one diol component, selected from aliphatic and alicyclic diols having 2 to 10 carbon atoms. Blends of aromatic polyester and aliphatic polyester also may be used for these. Examples of these include products marketed under the trade names HYTREL by E.I. DuPont de Nemours & Company, and SKYPEL by S.K. Chemicals of Seoul, South Korea.

Examples of other thermoplastic elastomers suitable as additional polymer components include those having functional groups, such as carboxylic acid, maleic anhydride, glycidyl, norbonene, and hydroxyl functionalities. An example of these includes a block polymer having at least one polymer block A comprising an aromatic vinyl compound and at least one polymer block B comprising a conjugated diene compound, and having a hydroxyl group at the terminal block copolymer, or its hydrogenated product. An example of this polymer is sold under the trade name SEPTON HG-252 by Kuraray Company of Kurashiki, Japan. Other examples of these include: maleic anhydride functionalized triblock copolymer consisting of polystyrene end blocks and poly(ethylene/butylene), sold under the trade name KRATON FG 1901X by Shell Chemical Company; maleic anhydride modified ethylene-vinyl acetate copolymer, sold under the trade name FUSABOND by E.I. DuPont de Nemours & Company; ethylene-isobutyl acrylate-methacrylic acid terpolymer, sold under the trade name NUCREL by E.I. DuPont de Nemours & Company; ethylene-ethyl acrylate-methacrylic anhydride terpolymer, sold under the trade name BONDINE AX 8390 and 8060 by Sumitomo Chemical Industries; brominated styrene-isobutylene copolymers sold under the trade name BROMO XP-50 by Exxon Mobil Corporation; and resins having glycidyl or maleic anhydride functional groups sold under the trade name LOTADER by Elf Atochem of Puteaux, France.

The other polymer materials may also include the polyamides. The term “polyamide” as used herein includes both homopolyamides and copolyamides. Illustrative polyamides for use in the polyalkenamer/polyamide compositions include those obtained by: (1) polycondensation of (a) a dicarboxylic acid, such as oxalic acid, adipic acid, sebacic acid, terephthalic acid, isophthalic acid, or 1,4-cyclohexanedicarboxylic acid, with (b) a diamine, such as ethylenediamine, tetramethylenediamine, pentamethylenediamine, hexamethylenediamine, decamethylenediamine, 1,4-cyclohexyldiamine or m-xylylenediamine; (2) a ring-opening polymerization of cyclic lactam, such as ε-caprolactam or ω-laurolactam; (3) polycondensation of an aminocarboxylic acid, such as 6-aminocaproic acid, 9-aminononanoic acid, 11-aminoundecanoic acid or 12-aminododecanoic acid; (4) copolymerization of a cyclic lactam with a dicarboxylic acid and a diamine; or any combination of (1)-(4). In certain examples, the dicarboxylic acid may be an aromatic dicarboxylic acid or a cycloaliphatic dicarboxylic acid. In certain examples, the diamine may be an aromatic diamine or a cycloaliphatic diamine Specific examples of suitable polyamides include polyamide 6; polyamide 11; polyamide 12; polyamide 4,6; polyamide 6,6; polyamide 6,9; polyamide 6,10; polyamide 6,12; polyamide MXD6; PA12, CX; PA12, IT; PPA; PA6, IT; and PA6/PPE. Also included are the crosslinked polyamide compositions descried in copending application 61/746,540 filed on the 27 Dec. 2012 in the name of the Taylor Made Golf Co. Inc and incorporated herein by reference in its entirety.

The polyamide (which may a polyamide as described above) may also be blended with a functional polymer modifier of. The functional polymer modifier of the polyamide can include copolymers or terpolymers having a glycidyl group, hydroxyl group, maleic anhydride group or carboxylic group, collectively referred to as functionalized polymers. These copolymers and terpolymers may comprise an α-olefin. Examples of suitable α-olefins include ethylene, propylene, 1-butene, 1-pentene, 3-methyl-1-butene, 1-hexene, 4-methyl-1-petene, 3-methyl-1-pentene, 1-octene, 1-decene-, 1-dodecene, 1-tetradecene, 1-hexadecene, 1-octadecene, 1-eicocene, 1-dococene, 1-tetracocene, 1-hexacocene, 1-octacocene, and 1-triacontene. One or more of these α-olefins may be used.

Examples of suitable glycidyl groups in copolymers or terpolymers in the polymeric modifier include esters and ethers of aliphatic glycidyl, such as allylglycidylether, vinylglycidylether, glycidyl maleate and itaconatem glycidyl acrylate and methacrylate, and also alicyclic glycidyl esters and ethers, such as 2-cyclohexene-1-glycidylether, cyclohexene-4,5 diglyxidylcarboxylate, cyclohexene-4-glycidyl carobxylate, 5-norboenene-2-methyl-2-glycidyl carboxylate, and endocis-bicyclo(2,2,1)-5-heptene-2,3-diglycidyl dicarboxylate. These polymers having a glycidyl group may comprise other monomers, such as esters of unsaturated carboxylic acid, for example, alkyl(meth)acrylates or vinyl esters of unsaturated carboxylic acids. Polymers having a glycidyl group can be obtained by copolymerization or graft polymerization with homopolymers or copolymers.

Examples of suitable terpolymers having a glycidyl group include LOTADER AX8900 and AX8920, marketed by Atofina Chemicals, ELVALOY marketed by E.I. Du Pont de Nemours & Co., and REXPEARL marketed by Nippon Petrochemicals Co., Ltd. Additional examples of copolymers comprising epoxy monomers and which are suitable for use within the scope of the present invention include styrene-butadiene-styrene block copolymers in which the polybutadiene block contains epoxy group, and styrene-isoprene-styrene block copolymers in which the polyisoprene block contains epoxy. Commercially available examples of these epoxy functional copolymers include ESBS A1005, ESBS A1010, ESBS A1020, ESBS AT018, and ESBS AT019, marketed by Daicel Chemical Industries, Ltd.

Examples of polymers or terpolymers incorporating a maleic anhydride group suitable for use within the scope of the present invention include maleic anhydride-modified ethylene-propylene copolymers, maleic anhydride-modified ethylene-propylene-diene terpolymers, maleic anhydride-modified polyethylenes, maleic anhydride-modified polypropylenes, ethylene-ethylacrylate-maleic anhydride terpolymers, and maleic anhydride-indene-styrene-cumarone polymers. Examples of commercially available copolymers incorporating maleic anhydride include: BONDINE, marketed by Sumitomo Chemical Co., such as BONDINE AX8390, an ethylene-ethyl acrylate-maleic anhydride terpolymer having a combined ethylene acrylate and maleic anhydride content of 32% by weight, and BONDINE TX TX8030, an ethylene-ethyl acrylate-maleic anhydride terpolymer having a combined ethylene acrylate and maleic anhydride content of 15% by weight and a maleic anhydride content of 1% to 4% by weight; maleic anhydride-containing LOTADER 3200, 3210, 6200, 8200, 3300, 3400, 3410, 7500, 5500, 4720, and 4700, marketed by Atofina Chemicals; EXXELOR VA1803, a maleic anhydride-modified ethylene-propylene copolymer having a maleic anhydride content of 0.7% by weight, marketed by Exxon Chemical Co.; and KRATON FG 1901X, a maleic anhydride functionalized triblock copolymer having polystyrene endblocks and poly(ethylene/butylene) midblocks, marketed by Shell Chemical.

Preferably the functional polymer component is a maleic anhydride grafted polymers preferably maleic anhydride grafted polyolefins (for example, Exxellor VA1803).

Styrenic block copolymers are copolymers of styrene with butadiene, isoprene, or a mixture of the two. Additional unsaturated monomers may be added to the structure of the styrenic block copolymer as needed for property modification of the resulting SBC/urethane copolymer. The styrenic block copolymer can be a diblock or a triblock styrenic polymer. Examples of such styrenic block copolymers are described in, for example, U.S. Pat. No. 5,436,295 to Nishikawa et al. The styrenic block copolymer can have any known molecular weight for such polymers, and it can possess a linear, branched, star, dendrimeric or combination molecular structure. The styrenic block copolymer can be unmodified by functional groups, or it can be modified by hydroxyl group, carboxyl group, or other functional groups, either in its chain structure or at one or more terminus. The styrenic block copolymer can be obtained using any common process for manufacture of such polymers. The styrenic block copolymers also may be hydrogenated using well-known methods to obtain a partially or fully saturated diene monomer block.

Other preferred materials suitable for use as additional polymers in the presently disclosed compositions include polyester thermoplastic elastomers marketed under the tradename SKYPEL™ by SK Chemicals of South Korea, or diblock or triblock copolymers marketed under the tradename SEPTON′ by Kuraray Corporation of Kurashiki, Japan, and KRATON′ by Kraton Polymers Group of Companies of Chester, United Kingdom. For example, SEPTON HG 252 is a triblock copolymer, which has polystyrene end blocks and a hydrogenated polyisoprene midblock and has hydroxyl groups at the end of the polystyrene blocks. HG-252 is commercially available from Kuraray America Inc. (Houston, Tex.).

A further example of a preferred materials suitable for use as additional polymers in the presently disclosed compositions is a specialty propylene elastomer as described, for example, in US 2007/0238552 A1, and incorporated herein by reference in its entirety. A specialty propylene elastomer includes a thermoplastic propylene-ethylene copolymer composed of a majority amount of propylene and a minority amount of ethylene. These copolymers have at least partial crystallinity due to adjacent isotactic propylene units. Although not bound by any theory, it is believed that the crystalline segments are physical crosslinking sites at room temperature, and at high temperature (i.e., about the melting point), the physical crosslinking is removed and the copolymer is easy to process. According to one embodiment, a specialty propylene elastomer includes at least about 50 mole % propylene co-monomer. Specialty propylene elastomers can also include functional groups such as maleic anhydride, glycidyl, hydroxyl, and/or carboxylic acid. Suitable specialty propylene elastomers include propylene-ethylene copolymers produced in the presence of a metallocene catalyst. More specific examples of specialty propylene elastomers are illustrated below. Specialty propylene elastomers are commercially available under the tradename VISTAMAXX from ExxonMobil Chemical.

An especially preferred component suitable for use as additional polymers in the presently disclosed golf balls include the polyalkenamers. The term “polyalkenamer” is used interchangeably herein with the term “polyalkenamer rubber” and means a rubbery polymer of one or more cycloalkenes having from 4-20, ring carbon atoms. The polyalkenamers may be prepared by ring opening metathesis polymerization of one or more cycloalkenes in the presence of organometallic catalysts as described in U.S. Pat. Nos. 3,492,245, and 3,804,803, the entire contents of both of which are herein incorporated by reference.

Another especially preferred component for use as an additional polymer in the presently disclosed golf balls include the carboxylated elastomers described in copending application No. 13/719,060 filed on Dec. 18, 2012 in the name of Taylor Made Golf Co., the entire contents of which are herein incorporated by reference. The term carboxylated elastomer (CE) composition as used herein is intended to mean the family of polymers which are long chain elastomeric rubbers containing pendant carboxyl groups at random various points along the chain as may be graphically illustrated below:

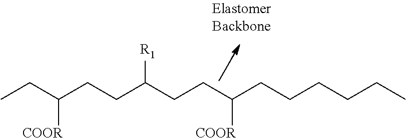

The carboxylated elastomer comprises an elastomer backbone and carboxy pendant groups, wherein R may be a hydrogen, a metal (for example, an alkali metal, an alkaline earth metal, or a transition metal), an ammonium or a quaternary ammonium group, an acyl group (for example acetyl (CH₃C(O)) group), an alkyl group (such as an ester), an acid anhydride group, and combinations thereof; and R₁ may be a hydrogen, an alkyl, or an aryl group. Although the pendant carboxy groups are depicted as being in interior positions along the elastomer backbone, the carboxylated elastomer may also include terminal carboxy groups occurring at one or more chain ends.
One method of introducing the carboxy groups is by copolymerization of a suitable olefin monomer with a monomer comprising a carboxy group. The first preparation of a carboxylic elastomer was recorded in 1933 and involved the copolymerization of butadiene and acrylic acid. Examples of suitable olefin monomers, include, but are not limited to, styrene, vinyltoluene, alpha-methylestyrene, butadiene, isoprene, hexadiene, dichlorovinylidene, vinylchloride, ethylene, propylene, butylene, and isobutylene. Examples of suitable monomers comprising a carboxy group include, but are not limited to, acrylic acid, alkyacrylate, alkyl alkacrylates, maleic anhydride, maleimide, acrylamide and 2-acrylamido-2-methyl-1-propane sulfonic acid.
A preferred class of carboxylated elastomers for use in this invention are the carboxylated nitrile rubbers which may be any of those known in the art. These are copolymers of butadiene, acrylonitrile and one or more α,μ-unsaturated carboxylic acids and which have nitrile rubber as the elastomer backbone. A diagram of the backbone is shown below.

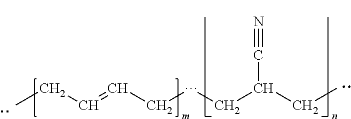

The carboxylic acids which are pendant to the above backbone may contain one or more carboxylic groups. Because of cost and availability, it is preferred that the carboxylic acids be selected from acrylic, methacrylic, fumaric, maleic and itaconic acids. The copolymers may be prepared by the well known emulsion free radical process. The acrylonitrile content of the copolymer may be from about 20 to about 40 percent by weight of the copolymer. The total content of carboxylic acid in the copolymer may be from about 0.5 to about 10 percent by weight of the copolymer. Butadiene forms the balance to 100 percent by weight of the copolymer. The viscosity of the copolymer is generally within the Mooney range (ML 1+4 at 100° C.) of from about 40 to about 80. U. S. Pat. Nos. 4, 271,052 and 4,525,517 disclose carboxylated nitrile rubbers for use in this invention and such disclosures are incorporated herein by reference. There are a number of carboxylated elastomers that are commercially available from Noveon under the tradename HYCAR including HYCAR CTBN 1300X8 and CTBN 1300X8F which are a carboxyl terminated butadiene-acrylonitrile copolymers. HYCAR VTBNX 1300X33 which is a methacrylate terminated butadiene-acrylonitrile copolymer and HYCAR ATBN 1300X16 is an amine terminated butadiene-acrylonitrile.

Another method for introducing the carboxy groups into the particular elastomer backbone is by grafting carboxy groups onto an elastomer backbone. The elastomers may include styrene butadiene random and block copolymers, hydrogenated styrene butadiene random and block copolymers, acrylonitrile butadiene styrene (“ABS”) copolymers, ethylene-propylene-diene-monomer (EPDM) copolymers, styrene-acrylic copolymers, acrylonitrile butadiene rubber (NBR) polymers, methylmethacrylate butadiene styrene (MBS) rubbers, and styrene-acrynitrile rubbers. Carboxy groups may be grafted onto a hydrophobic particulate elastomer to form a suitable graft particulate elastomer using a variety of suitable carboxylating materials, including, but not limited to, maleic acid, maleic anhydride, and diesters and monoesters of maleic acid, maleimide, fumaric acid and its derivatives, acrylic acid, alkylacrylate, alkylalkacrylates, acrylamide, 2-acrylamido-2-methyl-1-propanesulfonic acid and its salts.

Examples of suitable graft particulate elastomers include, but are not limited to, maleated polybutadienes, maleated styrene butadiene rubbers (“SBR”), maleated acrylonitrile-styrene-butadiene (“ABS”) rubbers, maleated nitrile-butadiene rubbers (“NBR”), maleated hydrogenated acrylonitrile butadiene rubbers (“HNBR”), methylmethacrylate butadiene styrene (“MBS”) rubbers, carboxylated ethylene-propylene-diene monomer rubbers, carboxylated styrene-acrynitrile rubbers (“SAN”), carboxylated ethylene propylene diene rubbers (“EPDM”), acrylic grafted silicone rubbers, and combinations thereof. An example of a suitable hydrogenated acrylonitrile butadiene rubber (“HNBR”) that is grafted with carboxylating materials is available from Lanxess Corporation, Leverkusen, Germany, under the trade name THERBAN® XT. An example of a suitable nitrile-butadiene rubbers (“NBR”) that is grafted with carboxylating materials is available from Zeon Chemicals, L.P., Louisville, Ky., under the trade name NIPOL® NBR 1072 CGX. Examples of suitable butadiene based rubbers that are grafted with carboxylating materials are available from Mitsubishi Rayon Company Ltd., Tokyo, Japan, under the trade names METABLENS® C and E. An example of an acrylic rubber that is grafted with carboxylating materials is available from Mitsubishi Rayon Company Limited, Tokyo, Japan, under the trade name METABLEN® W. An example of a suitable silicone based elastomer that is grafted with carboxylating materials is available from Mitsubishi Rayon America Inc., New York, N.Y., under the trade name METABLEN® S. An example of a suitable styrene butadiene particulate elastomer grafted with maleic acid available as an experimental product (Eliokem XPR-100) from Eliokem Corporation.

Most preferred are the grafted polyisoprene compounds including Kurary LIR403 which is a polyisoprene-graft-maleic anhydride having the following chemical structure:

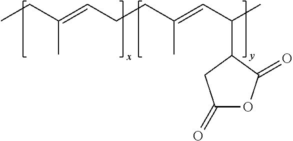

Also included is Kurary LIR410 which is a polyisoprene-graft-maleic anhydride monoester of maleic anhydride having the following chemical structure:

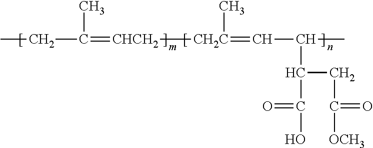

where n is approximately 10, and the material has a weight average molecular weight of about 25,000, and a glass transition temperature of −59° C.

If a given layer in a golf ball is not the one or more comprising the Li-catalyzed polybutadiene/polyalkenamer blend composition, the cover layer and/or one or more inner cover layers of the golf ball may comprise one or more thermoplastic or thermoset polyurethanes or polyureas. Polyurethanes or polyureas typically are prepared by reacting a diisocyanate with a polyol (in the case of polyurethanes) or with a polyamine (in the case of a polyurea). Thermoplastic polyurethanes or polyureas may consist solely of this initial mixture or may be further combined with a chain extender to vary properties such as hardness of the thermoplastic. Thermoset polyurethanes or polyureas typically are formed by the reaction of a diisocyanate and a polyol or polyamine respectively, and an additional crosslinking agent to crosslink or cure the material to result in a thermoset.

In what is known as a one-shot process, the three reactants, diisocyanate, polyol or polyamine, and optionally a chain extender or a curing agent, are combined in one step. Alternatively, a two-step process may occur in which the first step involves reacting the diisocyanate and the polyol (in the case of polyurethane) or the polyamine (in the case of a polyurea) to form a so-called prepolymer, to which can then be added either the chain extender or the curing agent. This procedure is known as the prepolymer process.

In addition, although depicted as discrete component packages as above, it is also possible to control the degree of crosslinking, and hence the degree of thermoplastic or thermoset properties in a final composition, by varying the stoichiometry not only of the diisocyanate-to-chain extender or curing agent ratio, but also the initial diisocyanate-to-polyol or polyamine ratio. Of course in the prepolymer process, the initial diisocyanate-to-polyol or polyamine ratio is fixed on selection of the required prepolymer.

Finally, in addition to discrete thermoplastic or thermoset materials, it also is possible to modify a thermoplastic polyurethane or polyurea composition by introducing materials in the composition that undergo subsequent curing after molding the thermoplastic to provide properties similar to those of a thermoset. For example, Kim in U.S. Pat. No. 6,924,337, the entire contents of which are hereby incorporated by reference, discloses a thermoplastic urethane or urea composition optionally comprising chain extenders and further comprising a peroxide or peroxide mixture, which can then undergo post curing to result in a thermoset. Also, Kim et al. in U.S. Pat. No. 6,939,924, the entire contents of which are hereby incorporated by reference, discloses a thermoplastic urethane or urea composition, optionally also comprising chain extenders, that is prepared from a diisocyanate and a modified or blocked diisocyanate which unblocks and induces further cross linking post extrusion. The modified isocyanate preferably is selected from the group consisting of: isophorone diisocyanate (IPDI)-based uretdione-type crosslinker; a combination of a uretdione adduct of IPDI and a partially e-caprolactam-modified IPDI; a combination of isocyanate adducts modified by e-caprolactam and a carboxylic acid functional group; a caprolactam-modified Desmodur diisocyanate; a Desmodur diisocyanate having a 3,5-dimethyl pyrazole modified isocyanate; or mixtures of these.

Finally, Kim et al. in U.S. Pat. No. 7,037,985 B2, the entire contents of which are hereby incorporated by reference, discloses thermoplastic urethane or urea compositions further comprising a reaction product of a nitroso compound and a diisocyanate or a polyisocyanate. The nitroso reaction product has a characteristic temperature at which it decomposes to regenerate the nitroso compound and diisocyanate or polyisocyanate. Thus, by judicious choice of the post-processing temperature, further crosslinking can be induced in the originally thermoplastic composition to provide thermoset-like properties.

In view of the advantages of injection molding versus the more complex casting process, under some circumstances it is advantageous to have formulations capable of curing as a thermoset but only within a specified temperature range above that of the typical injection molding process. This allows parts, such as golf ball cover layers, to be initially injection molded, followed by subsequent processing at higher temperatures and pressures to induce further crosslinking and curing, resulting in thermoset properties in the final part. Such an initially injection moldable composition is thus called a post curable urethane or urea composition.

If a post curable urethane composition is required, a modified or blocked diisocyanate which subsequently unblocks and induces further cross linking post extrusion may be included in the diisocyanate starting material. Modified isocyanates used for making the polyurethanes of the present invention generally are defined as chemical compounds containing isocyanate groups that are not reactive at room temperature, but that become reactive once they reach a characteristic temperature. The resulting isocyanates can act as crosslinking agents or chain extenders to form crosslinked polyurethanes. The degree of crosslinking is governed by type and concentration of modified isocyanate presented in the composition. The modified isocyanate used in the composition preferably is selected, in part, to have a characteristic temperature sufficiently high such that the urethane in the composition will retain its thermoplastic behavior during initial processing (such as injection molding). If a characteristic temperature is too low, the composition crosslinks before processing is completed, leading to process difficulties. The modified isocyanate preferably is selected from isophorone diisocyanate (IPDI)-based uretdione-type crosslinker; a combination of a uretdione adduct of IPDI and a partially e-caprolactam-modified IPDI; a combination of isocyanate adducts modified by e-caprolactam and a carboxylic acid functional group; a caprolactam-modified Desmodur diisocyanate; a Desmodur diisocyanate having a 3,5-dimethyl pyrazole modified isocyanate; or mixtures of these. Particular preferred examples of modified isocyanates include those marketed under the trade name CRELAN by Bayer Corporation. Examples of these include: CRELAN TP LS 2147; CRELAN NI 2; isophorone diisocyanate (IPDI)-based uretdione-type crosslinker, such as CRELAN VP LS 2347; a combination of a uretdione adduct of IPDI and a partially e-caprolactam-modified IPDI, such as CRELAN VP LS 2386; a combination of isocyanate adducts modified by e-caprolactam and a carboxylic acid functional group, such as CRELAN VP LS 2181/1; a caprolactam-modified Desmodur diisocyanate, such as CRELAN NW5; and a Desmodur diisocyanate having a 3,5-dimethyl pyrazole modified isocyanate, such as CRELAN XP 7180. These modified isocyanates may be used either alone or in combination. Such modified diisocyanates are described in more detail in U.S. Pat. No. 6,939,924, the entire contents of which are hereby incorporated by reference.

As an alternative if a post curable polyurethane or polyurea composition is required, the diisocyanate may further comprise reaction product of a nitroso compound and a diisocyanate or a polyisocyanate. The reaction product has a characteristic temperature at which it decomposes regenerating the nitroso compound and diisocyanate or polyisocyanate, which can, by judicious choice of the post processing temperature, in turn induce further crosslinking in the originally thermoplastic composition resulting in thermoset-like properties. Such nitroso compounds are described in more detail in U.S. Pat. No. 7,037,985 B2, the entire contents of which are hereby incorporated by reference.

If a given layer in a golf ball is not the one or more comprising the Li-catalyzed polybutadiene/polyalkenamer blend composition, the cover layer and/or one or more inner cover layers of the golf ball may comprise one or more ionomer resins. One family of such resins was developed in the mid-1960's, by E.I. DuPont de Nemours and Co., and sold under the trademark SURLYN®. Preparation of such ionomers is well known, for example see U.S. Pat. No. 3,264,272. Generally speaking, most commercial ionomers are unimodal and consist of a polymer of a mono-olefin, e.g., an alkene, with an unsaturated mono- or dicarboxylic acids having 3 to 12 carbon atoms. An additional monomer in the form of a mono- or dicarboxylic acid ester may also be incorporated in the formulation as a so-called “softening comonomer”. The incorporated carboxylic acid groups are then neutralized by a basic metal ion salt, to form the ionomer. The metal cations of the basic metal ion salt used for neutralization include Li⁺, Na⁺, K⁺, Zn²⁺, Ca²⁺, Co²⁺, Ni²⁺, Cu²⁺, Pb²⁺, and Mg²⁺, with the Li⁺, Na⁺, Ca²⁺, Zn²⁺, and Mg²⁺ being preferred. The basic metal ion salts include those of for example formic acid, acetic acid, nitric acid, and carbonic acid, hydrogen carbonate salts, oxides, hydroxides, and alkoxides.

Today, there are a wide variety of commercially available ionomer resins based both on copolymers of ethylene and (meth)acrylic acid or terpolymers of ethylene and (meth)acrylic acid and (meth)acrylate, all of which can be used as a golf ball component. The properties of these ionomer resins can vary widely due to variations in acid content, softening comonomer content, the degree of neutralization, and the type of metal ion used in the neutralization. The full range commercially available typically includes ionomers of polymers of general formula, E/X/Y polymer, wherein E is ethylene, X is a C₃ to C₈ α,β ethylenically unsaturated carboxylic acid, such as acrylic or methacrylic acid, and is present in an amount from about 0 wt. % to about 50 wt. %, particularly about 2 to about 30 weight %, of the E/X/Y copolymer, and Y is a softening comonomer selected from the group consisting of alkyl acrylate and alkyl methacrylate, such as methyl acrylate or methyl methacrylate, and wherein the alkyl groups have from 1-8 carbon atoms, Y is in the range of 0 to about 50 weight %, particularly about 5 wt. % to about 35 wt. %, of the E/X/Y copolymer, and wherein the acid groups present in said ionomeric polymer are partially (e.g., about 1% to about 90%) neutralized with a metal selected from the group consisting of lithium, sodium, potassium, magnesium, calcium, barium, lead, tin, zinc or aluminum, or a combination of such cations.

The ionomer may also be a so-called bimodal ionomer as described in U.S. Pat. No. 6,562,906 (the entire contents of which are herein incorporated by reference). These ionomers are bimodal as they are prepared from blends comprising polymers of different molecular weights. Specifically they include bimodal polymer blend compositions comprising:
a) a high molecular weight component having a molecular weight of about 80,000 to about 500,000 and comprising one or more ethylene/α,β-ethylenically unsaturated C₃₋₈ carboxylic acid copolymers and/or one or more ethylene, alkyl (meth)acrylate, (meth)acrylic acid terpolymers; said high molecular weight component being partially neutralized with metal ions selected from the group consisting of lithium, sodium, zinc, calcium, magnesium, and a mixture of any these; and
b) a low molecular weight component having a molecular weight of about from about 2,000 to about 30,000 and comprising one or more ethylene/α,β-ethylenically unsaturated C₃₋₈ carboxylic acid copolymers and/or one or more ethylene, alkyl (meth)acrylate, (meth)acrylic acid terpolymers; said low molecular weight component being partially neutralized with metal ions selected from the group consisting of lithium, sodium, zinc, calcium, magnesium, and a mixture of any these.

In addition to the unimodal and bimodal ionomers, also included are the so-called “modified ionomers” examples of which are described in U.S. Pat. Nos. 6,100,321, 6,329,458 and 6,616,552 and U.S. Patent Publication No. US 2003/0158312 A1, the entire contents of all of which are herein incorporated by reference.

The modified unimodal ionomers may be prepared by mixing:
a) an ionomeric polymer comprising ethylene, from 5 to 25 weight percent (meth)acrylic acid, and from 0 to 40 weight percent of a (meth)acrylate monomer, said ionomeric polymer neutralized with metal ions selected from the group consisting of lithium, sodium, zinc, calcium, magnesium, and a mixture of any of these; and
b) from about 5 to about 40 weight percent (based on the total weight of said modified ionomeric polymer) of one or more fatty acids or metal salts of said fatty acid, the metal selected from the group consisting of calcium, sodium, zinc, potassium, and lithium, barium and magnesium and the fatty acid preferably being stearic acid.

The modified bimodal ionomers, which are ionomers derived from the earlier described bimodal ethylene/carboxylic acid polymers (as described in U.S. Pat. No. 6,562,906, the entire contents of which are herein incorporated by reference), are prepared by mixing;
a) a high molecular weight component having a weight average molecular weight (M_{w}) of about 80,000 to about 500,000 and comprising one or more ethylene/α, β-ethylenically unsaturated C₃₋₈ carboxylic acid copolymers and/or one or more ethylene, alkyl (meth)acrylate, (meth)acrylic acid terpolymers; said high molecular weight component being partially neutralized with metal ions selected from the group consisting of lithium, sodium, zinc, calcium, potassium, magnesium, and a mixture of any of these; and
b) a low molecular weight component having a weight average molecular weight (M_{w}) of about from about 2,000 to about 30,000 and comprising one or more ethylene/α,β-ethylenically unsaturated C₃₋₈ carboxylic acid copolymers and/or one or more ethylene, alkyl (meth)acrylate, (meth)acrylic acid terpolymers; said low molecular weight component being partially neutralized with metal ions selected from the group consisting of lithium, sodium, zinc, calcium, potassium, magnesium, and a mixture of any of these; and
c) from about 5 to about 40 weight percent (based on the total weight of said modified ionomeric polymer) of one or more fatty acids or metal salts of said fatty acid, the metal selected from the group consisting of calcium, sodium, zinc, potassium and lithium, barium and magnesium and the fatty acid preferably being stearic acid.

The fatty or waxy acid salts utilized in the various modified ionomers are composed of a chain of alkyl groups containing from about 4 to 75 carbon atoms (usually even numbered) and characterized by a —COOH terminal group. The generic formula for all fatty and waxy acids above acetic acid is CH₃ (CH₂)ₓ COOH, wherein the carbon atom count includes the carboxyl group. The fatty or waxy acids utilized to produce the fatty or waxy acid salts modifiers may be saturated or unsaturated, and they may be present in solid, semi-solid or liquid form.

Examples of suitable saturated fatty acids, i.e., fatty acids in which the carbon atoms of the alkyl chain are connected by single bonds, include but are not limited to stearic acid (C₁₈, i.e., CH₃ (CH₂)₁₆COOH), palmitic acid (C₁₆, i.e., CH₃ (CH₂)₁₄COOH), pelargonic acid (C₉, i.e., CH₃ (CH₂)₇COOH) and lauric acid (Cu, i.e., CH₃ (CH₂)₁₀OCOOH). Examples of suitable unsaturated fatty acids, i.e., a fatty acid in which there are one or more double bonds between the carbon atoms in the alkyl chain, include but are not limited to oleic acid (C₁₃, i.e., CH₃ (CH₂)₇CH:CH(CH₂)₇COOH).

The source of the metal ions used to produce the metal salts of the fatty or waxy acid salts used in the various modified ionomers are generally various metal salts which provide the metal ions capable of neutralizing, to various extents, the carboxylic acid groups of the fatty acids. These include the sulfate, carbonate, acetate and hydroxylate salts of zinc, barium, calcium and magnesium.

Since the fatty acid salts modifiers comprise various combinations of fatty acids neutralized with a large number of different metal ions, several different types of fatty acid salts may be utilized in the invention, including metal stearates, laureates, oleates, and palmitates, with calcium, zinc, sodium, lithium, potassium and magnesium stearate being preferred, and calcium and sodium stearate being most preferred.

The fatty or waxy acid or metal salt of said fatty or waxy acid is present in the modified ionomeric polymers in an amount of from about 5 to about 40, preferably from about 7 to about 35, more preferably from about 8 to about 20 weight percent (based on the total weight of said modified ionomeric polymer).

As a result of the addition of the one or more metal salts of a fatty or waxy acid, from about 40 to 100, preferably from about 50 to 100, more preferably from about 70 to 100 percent of the acidic groups in the final modified ionomeric polymer composition are neutralized by a metal ion. An example of such a modified ionomer polymer is DuPont® HPF-1000 available from E. I. DuPont de Nemours and Co. Inc.

If a given layer in a golf ball is not the one or more comprising the PHPB composition, the cover layer and/or one or more inner cover layers of the golf ball may comprise a blend of an ionomer and a block copolymer. An example of a block copolymer is a functionalized styrenic block copolymer, the block copolymer incorporating a first polymer block having an aromatic vinyl compound, a second polymer block having a conjugated diene compound in which the ratio of block copolymer to ionomer ranges from 5:95 to 95:5 by weight, more preferably from about 10:90 to about 90:10 by weight, more preferably from about 20:80 to about 80:20 by weight, more preferably from about 30:70 to about 70:30 by weight and most preferably from about 35:65 to about 65:35 by weight. A preferred block copolymer is SEPTON HG-252. Such blends are described in more detail in commonly-assigned U.S. Pat. No. 6,861,474 and U.S. Patent Publication No. 2003/0224871 both of which are incorporated herein by reference in their entireties.

Another preferred material which also may be used as a separate component of the cover layer or intermediate layer of the golf balls of the present invention is a multi-component blend composition (“MCBC”) prepared by blending together at least three materials, identified as Components A, B, and C, and melt-processing these components to form in-situ, a polymer blend composition incorporating a pseudo-crosslinked polymer network. Such blends are more fully described in U.S. Pat. No. 6,930,150 to H J Kim, the entire contents of which are hereby incorporated by reference.

The first of these blend components (blend Component A) include block copolymers including di and triblock copolymers, incorporating a first polymer block having an aromatic vinyl compound, and a second polymer block having an olefinic and/or conjugated diene compound. Preferred aromatic vinyl compounds include styrene, α-methylstyrene, o-, m- or p-methylstyrene, 4-propylstyrene, 1,3-dimethylstyrene, vinylnaphthalene and vinylanthracene. In particular, styrene and α-methylstyrene are preferred. These aromatic vinyl compounds can each be used alone, or can be used in combination of two or more kinds. The aromatic vinyl compound is preferably contained in the block copolymer (b) in an amount of from 5 to 75% by weight, and more preferably from 10 to 65% by weight.

The conjugated diene compound, that constitutes the polymer block B in the block copolymer (b), includes, e.g., 1, 3-butadiene, isoprene, 2, 3-dimethyl-1, 3-butadiene, 1, 3-pentadiene and 1, 3-hexadiene. In particular, isoprene and 1, 3-butadiene are preferred. These conjugated diene compounds can each be used alone, or can be used in combination of two or more kinds.

Preferred block copolymers include the styrenic block copolymers such as styrene-butadiene-styrene (SBS), styrene-ethylene-butylene-styrene, (SEBS) and styrene-ethylene-propylene-styrene (SEPS). Commercial examples include SEPTON marketed by Kuraray Company of Kurashiki, Japan; TOPRENE by Kumho Petrochemical Co., Ltd and KRATON marketed by Kraton Polymers.

Also included are functionalized styrenic block copolymers, including those where the block copolymer incorporates a first polymer block having an aromatic vinyl compound, a second polymer block having a conjugated diene compound and a hydroxyl group located at a block copolymer, or its hydrogenation product. A preferred functionalized styrenic block copolymer is SEPTON HG-252.

The second blend component, Component B, is an acidic polymer that incorporates at least one type of an acidic functional group. Examples of such polymers suitable for use as include, but are not limited to, ethylene/(meth)acrylic acid copolymers and ethylene/(meth)acrylic acid/alkyl (meth)acrylate terpolymers, or ethylene and/or propylene maleic anhydride copolymers and terpolymers. Examples of such polymers which are commercially available include, but are not limited to, the Escor® 5000, 5001, 5020, 5050, 5070, 5100, 5110 and 5200 series of ethylene-acrylic acid copolymers sold by Exxon Mobil, the PRIMACOR® 1321, 1410, 1410-XT, 1420, 1430, 2912, 3150, 3330, 3340, 3440, 3460, 4311, 4608 and 5980 series of ethylene-acrylic acid copolymers sold by The Dow Chemical Company, Midland, Mich. and the ethylene-methacrylic acid copolymers such as Nucrel 599, 699, 0903, 0910, 925, 960, 2806, and 2906 commercially available from DuPont

Also included are the so called bimodal ethylene/carboxylic acid polymers as described in U.S. Pat. No. 6,562,906, the contents of which are incorporated herein by reference. These polymers comprise a first component comprising an ethylene/α,β-ethylenically unsaturated C₃₋₈ carboxylic acid high copolymer, particularly ethylene (meth)acrylic acid copolymers and ethylene, alkyl (meth)acrylate, (meth)acrylic acid terpolymers, having a weight average molecular weight, Mw, of about 80,000 to about 500,000, and a second component comprising an ethylene/α,β-ethylenically unsaturated C₃₋₈ carboxylic acid copolymers, particularly ethylene/(meth)acrylic acid copolymers having weight average molecular weight, Mw, of about 2,000 to about 30,000.

Component C is a base capable of neutralizing the acidic functional group of Component B and typically is a base having a metal cation. These metals are from groups IA, IB, IIA, IIB, IIIA, IIIB, IVA, IVB, VA, VB, VIA, VIB, VIIB and VIIIB of the periodic table. Examples of these metals include lithium, sodium, magnesium, aluminum, potassium, calcium, manganese, tungsten, titanium, iron, cobalt, nickel, hafnium, copper, zinc, barium, zirconium, and tin. Suitable metal compounds for use as a source of Component C are, for example, metal salts, preferably metal hydroxides, metal oxides, metal carbonates, metal acetates, metal stearates, metal laureates, metal oleates, metal palmitates and the like.

The MCBC composition preferably is prepared by mixing the above materials into each other thoroughly, either by using a dispersive mixing mechanism, a distributive mixing mechanism, or a combination of these. These mixing methods are well known in the manufacture of polymer blends. As a result of this mixing, the acidic functional group of Component B is dispersed evenly throughout the mixture in either their neutralized or non-neutralized state. Most preferably, Components A and B are melt-mixed together without Component C, with or without the premixing discussed above, to produce a melt-mixture of the two components. Then, Component C separately is mixed into the blend of Components A and B. This mixture is melt-mixed to produce the reaction product. This two-step mixing can be performed in a single process, such as, for example, an extrusion process using a proper barrel length or screw configuration, along with a multiple feeding system.

The Li-catalyzed polybutadiene/polyalkenamer blend and the various other polymer compositions used to prepare core, mantle or outer cove layers of the golf balls of the present invention may also incorporate one or more fillers. Such fillers are typically in a finely divided form, for example, in a size generally less than about 20 mesh, preferably less than about 100 mesh U.S. standard size, except for fibers and flock, which are generally elongated. Flock and fiber sizes should be small enough to facilitate processing. Filler particle size will depend upon desired effect, cost, ease of addition, and dusting considerations. The appropriate amounts of filler required will vary depending on the application but typically can be readily determined without undue experimentation.

The filler preferably is selected from the group consisting of precipitated hydrated silica, limestone, clay, talc, asbestos, barytes, glass fibers, aramid fibers, mica, calcium metasilicate, barium sulfate, zinc sulfide, lithopone, silicates, silicon carbide, diatomaceous earth, carbonates such as calcium or magnesium or barium carbonate, sulfates such as calcium or magnesium or barium sulfate, metals, including tungsten steel copper, cobalt or iron, metal alloys, tungsten carbide, metal oxides, metal stearates, and other particulate carbonaceous materials, and any and all combinations thereof. Preferred examples of fillers include metal oxides, such as zinc oxide and magnesium oxide. In another preferred embodiment the filler comprises a continuous or non-continuous fiber.

In another preferred embodiment the filler comprises one or more so called nanofillers, as described in U.S. Pat. No. 6,794,447 and copending U.S. Publication No. US2004-0092336 filed on Sep. 24, 2003 and U.S. Pat. No. 7,332,533 filed on Aug. 25, 2004, the entire contents of each of which are incorporated herein by reference. Examples of commercial nanofillers are various Cloisite grades including 10A, 15A, 20A, 25A, 30B, and NA+ of Southern Clay Products (Gonzales, Tex.) and the Nanomer grades including 1.24TL and C.30EVA of Nanocor, Inc. (Arlington Heights, Ill.).

Materials incorporating nanofiller materials can provide these property improvements at much lower densities than those incorporating conventional fillers. For example, a nylon-6 nanocomposite material manufactured by RTP Corporation of Wichita, Kans. uses a 3% to 5% clay loading and has a tensile strength of 11,800 psi and a specific gravity of 1.14, while a conventional 30% mineral-filled material has a tensile strength of 8,000 psi and a specific gravity of 1.36. Because use of nanocomposite materials with lower loadings of inorganic materials than conventional fillers provides the same properties, this use allows products to be lighter than those with conventional fillers, while maintaining those same properties.

As used herein, a “nanocomposite” is defined as a polymer matrix having nanofiller intercalated or exfoliated within the matrix. Physical properties of the polymer will change with the addition of nanofiller and the physical properties of the polymer are expected to improve even more as the nanofiller is dispersed into the polymer matrix to form a nanocomposite.

Nanocomposite materials are materials incorporating from about 0.1% to about 20%, preferably from about 0.1% to about 15%, and most preferably from about 0.1% to about 10% of nanofiller reacted into and substantially dispersed through intercalation or exfoliation into the structure of an organic material, such as a polymer, to provide strength, temperature resistance, and other property improvements to the resulting composite. Descriptions of particular nanocomposite materials and their manufacture can be found in U.S. Pat. No. 5,962,553 to Ellsworth, U.S. Pat. No. 5,385,776 to Maxfield et al., and U.S. Pat. No. 4,894,411 to Okada et al. Examples of nanocomposite materials currently marketed include M1030D, manufactured by Unitika Limited, of Osaka, Japan, and 1015C2, manufactured by UBE America of New York, N.Y.

Preferably the nanofiller material is added to the polymeric composition in an amount of from about 0.1% to about 20%, preferably from about 0.1% to about 15%, and most preferably from about 0.1% to about 10% by weight of nanofiller reacted into and substantially dispersed through intercalation or exfoliation into the structure of the polymeric composition.

If desired, the various polymer compositions used to prepare the golf balls can additionally contain other additives such as plasticizers, pigments, antioxidants, U.V. absorbers, optical brighteners, or any other additives generally employed in plastics formulation or the preparation of golf balls.

Another particularly well-suited additive for use in the presently disclosed compositions includes compounds having the general formula:

(R₂N)ₘ—R′—(X(O)ₙOR_{y})ₘ,

where R is hydrogen, or a C₁-C₂₀ aliphatic, cycloaliphatic or aromatic systems; R′ is a bridging group comprising one or more C₁-C₂₀ straight chain or branched aliphatic or alicyclic groups, or substituted straight chain or branched aliphatic or alicyclic groups, or aromatic group, or an oligomer of up to 12 repeating units including, but not limited to, polypeptides derived from an amino acid sequence of up to 12 amino acids; and X is C or S or P with the proviso that when X═C, n=1 and y=1 and when X═S, n=2 and y=1, and when X═P, n=2 and y=2. Also, m=1-3. These materials are more fully described in copending U.S. Provisional Patent Application No. 60/588,603, filed on Jul. 16, 2004, the entire contents of which are herein incorporated by reference. These materials include caprolactam, oenantholactam, decanolactam, undecanolactam, dodecanolactam, caproic 6-amino acid, 11-aminoundecanoicacid, 12-aminododecanoic acid, diamine hexamethylene salts of adipic acid, azeleic acid, sebacic acid and 1,12-dodecanoic acid and the diamine nonamethylene salt of adipic acid, 2-aminocinnamic acid, L-aspartic acid, 5-aminosalicylic acid, aminobutyric acid; aminocaproic acid; aminocapyryic acid; 1-(aminocarbonyl)-1-cyclopropanecarboxylic acid; aminocephalosporanic acid; aminobenzoic acid; aminochlorobenzoic acid; 2-(3-amino-4-chlorobenzoyl)benzoic acid; aminonaphtoic acid; aminonicotinic acid; aminonorbornanecarboxylic acid; aminoorotic acid; aminopenicillanic acid; aminopentenoic acid; (aminophenyl)butyric acid; aminophenyl propionic acid; aminophthalic acid; aminofolic acid; aminopyrazine carboxylic acid; aminopyrazole carboxylic acid; aminosalicylic acid; aminoterephthalic acid; aminovaleric acid; ammonium hydrogencitrate; anthranillic acid; aminobenzophenone carboxylic acid; aminosuccinamic acid, epsilon-caprolactam; omega-caprolactam, (carbamoylphenoxy)acetic acid, sodium salt; carbobenzyloxy aspartic acid; carbobenzyl glutamine; carbobenzyloxyglycine; 2-aminoethyl hydrogensulfate; aminonaphthalenesulfonic acid; aminotoluene sulfonic acid; 4,4′-methylene-bis-(cyclohexylamine)carbamate and ammonium carbamate.

Most preferably the material is selected from the group consisting of 4,4′-methylene-bis-(cyclohexylamine)carbamate (commercially available from R.T. Vanderbilt Co., Norwalk, Conn. under the tradename Diak® 4), 11-aminoundecanoicacid, 12-aminododecanoic acid, epsilon-caprolactam; omega-caprolactam, and any and all combinations thereof.

In an especially preferred embodiment a nanofiller additive component in the golf ball is surface modified with a compatibilizing agent comprising the earlier described compounds having the general formula:

(R₂N)ₘ—R′—(X(O)ₙOR_{y})ₘ,

A most preferred embodiment would be a filler comprising a nanofiller clay material surface modified with an amino acid including 12-aminododecanoic acid. Such fillers are available from Nanonocor Co. under the tradename Nanomer 1.24TL.

Disclosed compositions have sufficient shear-cut resistance and excellent mechanical properties that make them suitable for making sports equipment, such as a recreation ball, a golf club or component thereof, such as a grip, shoes, glove, helmet, protective gears, bicycle, football, soccer, basketball, baseball, volley ball, hockey, ski, skate and the like.

The cores of the golf balls of the present invention may include the traditional rubber components used in golf ball applications including, both natural and synthetic rubbers, such as cis-1,4-polybutadiene, trans-1,4-polybutadiene, 1,2-polybutadiene, cis-polyisoprene, trans-polyisoprene, polychloroprene, polybutylene, styrene-butadiene rubber, styrene-butadiene-styrene block copolymer and partially and fully hydrogenated equivalents, styrene-isoprene-styrene block copolymer and partially and fully hydrogenated equivalents, nitrile rubber, silicone rubber, and polyurethane, as well as mixtures of these. Polybutadiene rubbers, especially 1,4-polybutadiene rubbers containing at least 40 mol %, and more preferably 80 to 100 mol % of cis-1,4 bonds, are preferred because of their high rebound resilience, moldability, and high strength after vulcanization. The polybutadiene component may be synthesized by using rare earth-based catalysts, nickel-based catalysts, or cobalt-based catalysts, conventionally used in this field. Polybutadiene obtained by using lanthanum rare earth-based catalysts usually employ a combination of a lanthanum rare earth (atomic number of 57 to 71) -compound, but particularly preferred is a neodymium compound.

The 1,4-polybutadiene rubbers have a molecular weight distribution (Mw/Mn) of from about 1.2 to about 4.0, preferably from about 1.7 to about 3.7, even more preferably from about 2.0 to about 3.5, most preferably from about 2.2 to about 3.2. The polybutadiene rubbers have a Mooney viscosity (ML₁₊₄ (100° C.)) of from about 20 to about 80, preferably from about 30 to about 70, even more preferably from about 30 to about 60, most preferably from about 35 to about 50. The term “Mooney viscosity” used herein refers in each case to an industrial index of viscosity as measured with a Mooney viscometer, which is a type of rotary plastometer (see JIS K6300). This value is represented by the symbol ML₁₊₄ (100° C.), wherein “M” stands for Mooney viscosity, “L” stands for large rotor (L-type), “1+4” stands for a pre-heating time of 1 minute and a rotor rotation time of 4 minutes, and “100° C.” indicates that measurement was carried out at a temperature of 100° C. As readily appreciated by one skilled in the art, blends of polybutadiene rubbers may also be utilized in the golf balls of the present invention, such blends may be prepared with any mixture of rare earth-based catalysts, nickel-based catalysts, or cobalt-based catalysts derived materials, and from materials having different molecular weights, molecular weight distributions and Mooney viscosity.

The cores of the golf balls of the present invention may also include 1,2-polybutadienes having differing tacticity, all of which are suitable as unsaturated polymers for use in the presently disclosed compositions, are atactic 1,2-polybutadiene, isotactic 1,2-polybutadiene, and syndiotactic 1,2-polybutadiene. Syndiotactic 1,2-polybutadiene having crystallinity suitable for use as an unsaturated polymer in the presently disclosed compositions are polymerized from a 1,2-addition of butadiene. The presently disclosed golf balls may include syndiotactic 1,2-polybutadiene having crystallinity and greater than about 70% of 1,2-bonds, more preferably greater than about 80% of 1,2-bonds, and most preferably greater than about 90% of 1,2-bonds. Also, the 1,2-polybutadiene may have a mean molecular weight between about 10,000 and about 350,000, more preferably between about 50,000 and about 300,000, more preferably between about 80,000 and about 200,000, and most preferably between about 10,000 and about 150,000. Examples of suitable syndiotactic 1,2-polybutadienes having crystallinity suitable for use in golf balls are sold under the trade names RB810, RB820, and RB830 by JSR Corporation of Tokyo, Japan.

The cores of the golf balls of the present invention may also include the polyalkenamer rubbers as previously described herein and disclosed in U.S. Pat. No. 7,528,196 in the name of Hyun Kim et al., the entire contents of which are hereby incorporated by reference.

Typically the golf ball core is made by mixing together the unsaturated polymer, cross-linking agents, and other additives with or without melting them. Dry blending equipment, such as a tumbler mixer, V blender, ribbon blender, or two-roll mill, can be used to mix the compositions. The golf ball core compositions can also be mixed using a mill, internal mixer such as a Banbury or Farrel continuous mixer, extruder or combinations of these, with or without application of thermal energy to produce melting. The various core components can be mixed together with the cross-linking agents, or each additive can be added in an appropriate sequence to the milled unsaturated polymer. In another method of manufacture the cross-linking agents and other components can be added to the unsaturated polymer as part of a concentrate using dry blending, roll milling, or melt mixing. If radiation is a cross-linking agent, then the mixture comprising the unsaturated polymer and other additives can be irradiated following mixing, during forming into a part such as the core of a ball, or after forming.

The resulting mixture can be subjected to, for example, a compression or injection molding process, to obtain solid spheres for the core. The polymer mixture is subjected to a molding cycle in which heat and pressure are applied while the mixture is confined within a mold. The cavity shape depends on the portion of the golf ball being formed. The compression and heat liberates free radicals by decomposing one or more peroxides, which initiate cross-linking. The temperature and duration of the molding cycle are selected based upon the type of peroxide and peptizer selected. The molding cycle may have a single step of molding the mixture at a single temperature for fixed time duration.

For example, a preferred mode of preparation for the cores used in the present invention is to first mix the core ingredients on a two-roll mill, to form slugs of approximately 30-40 g, and then compression-mold in a single step at a temperature between 150 to 180° C., for a time duration between 5 and 12 minutes.

The various core components may also be combined to form a golf ball by an injection molding process, which is also well known to one of ordinary skill in the art. The curing time depends on the various materials selected, and those of ordinary skill in the art will be readily able to adjust the curing time upward or downward based on the particular materials used and the discussion herein.

The various formulations for the mantle layer and/or outer cover layer may be produced by any generally known method, such as dry blending, melt-mixing, or combination of those, to achieve a good dispersive mixing, distributive mixing, or both. Examples of melt-mixing are roll-mill; internal mixer, such as injection molding, single-screw extruder, twin-screw extruder; or any combination of those The feed to the injection mold may be blended manually or mechanically prior to the addition to the injection molder feed hopper. Finished golf balls may be prepared by initially positioning the solid, preformed core in an injection-molding cavity, followed by uniform injection of the intermediate layer and/or cover layer composition sequentially over the core. The cover formulations can be injection molded around the cores to produce golf balls of the required diameter.

Alternatively, the mantle layers and/or outer cover layer may also be formed around the core by first forming half shells by injection molding followed by compression molding the half shells about the core to form the final ball.

The mantle layers and/or outer cover layer may also be formed around the cores using compression molding. Cover materials for compression molding may also be extruded or blended resins or castable resins such as thermoset polyurethane or thermoset polyurea.

In one preferred aspect the Li-catalyzed polybutadiene/polyalkenamer blend material used in the present invention may be crosslinked using a composition comprising one or more peroxides in a total amount of from about 0.1 to about 5, preferably of from about 0.5 to about 3, and more preferably of from about 0.75 to about 1.5 pph based on the total weight of blend.

The crosslinking composition also comprises at least one zinc or magnesium salt of an unsaturated fatty acids having 3 to 8 carbon atoms selected from the group consisting of acrylic acid, methacrylic acid, maleic acid, stearic acid, fumaric acid, palmitic acid and mixtures thereof present in an amount of from about less than about 150, preferably less than about 125, and more preferably less than about 100 pph and more preferably of from about 5 to about 100 pph based on the total weight of the blend.

This mechanism is known as free radical crosslinking. The blend composition the may be crosslinked by this crosslinking package before or after its incorporation into the blend composition.

The Li-catalyzed polybutadiene/polyalkenamer blend material has a Melt Flow Index (MFI) of from about 1 to about 80, preferably of from about 4 to about 60, more preferably of from about 5 to about 50 and most preferably of from about 10 to about 30 g/10 min.

The Li-catalyzed polybutadiene/polyalkenamer blend material has a material hardness of from about 20 to about 90, preferably of from about 25 to about 85 more preferably of from about 30 to about 80 and most preferably of from about 35 to about 70 Shore D.

The Li-catalyzed polybutadiene/polyalkenamer blend material has a flex modulus of from about 1 to about 120, preferably of from about 2 to about 100, more preferably of from about 3 to about 90 and most preferably of from about 4 to about 70 kpsi.

The golf ball of the present invention comprises a core and may comprise from 0 to 6, preferably from 0 to 5, more preferably from about 1 to about 4, most preferably from about 1 to about 3 intermediate or mantle layer(s).

In one preferred aspect, the golf ball is a three-piece ball with the Li-catalyzed polybutadiene/polyalkenamer blend composition used in the mantle layer.

In one preferred aspect, the golf ball is a four-piece, five-piece, or six-piece ball having at least one mantle layer which comprises the Li-catalyzed polybutadiene/polyalkenamer blend material described herein.

In another aspect the golf ball is a three-piece ball with the intermediate or mantle layer comprising the Li-catalyzed polybutadiene/polyalkenamer blend material and the outer cover layer comprises a block copolymer, an acidic polymer, a unimodal ionomer, a bimodal ionomer, a modified unimodal ionomer, a modified bimodal ionomer, a polyalkenamer, a polyamide, a thermoplastic or thermoset polyurethane or thermoplastic or thermoset polyurea, or a multicomponent blend composition (“MCBC”), the MCBC comprising (A) a block copolymer; and (B) one or more acidic polymers; and (C) one or more basic metal salts present in an amount to neutralize at greater than or equal to about 30 percent of the acid groups of Component (B), and any and all combinations thereof.

In another aspect the golf ball is a four-piece ball with a unitary core and one or both of the mantle layers comprises the Li-catalyzed polybutadiene/polyalkenamer blend material and the outer cover layer comprises a block copolymer, an acidic polymer, a unimodal ionomer, a bimodal ionomer, a modified unimodal ionomer, a modified bimodal ionomer, a polyalkenamer, a polyamide, a thermoplastic or thermoset polyurethane or thermoplastic or thermoset polyurea, or a multicomponent blend composition (“MCBC”), the MCBC comprising (A) a block copolymer; and (B) one or more acidic polymers; and (C) one or more basic metal salts present in an amount to neutralize at greater than or equal to about 30 percent of the acid groups of Component (B), and any and all combinations thereof.

In another aspect the golf ball is a five-piece ball with a unitary core and one or more of the three mantle layers comprises the Li-catalyzed polybutadiene/polyalkenamer blend material and the outer cover layer comprises a block copolymer, an acidic polymer, a unimodal ionomer, a bimodal ionomer, a modified unimodal ionomer, a modified bimodal ionomer, a polyalkenamer, a polyamide, a thermoplastic or thermoset polyurethane or thermoplastic or thermoset polyurea, or a multicomponent blend composition (“MCBC”), the MCBC comprising (A) a block copolymer; and (B) one or more acidic polymers; and (C) one or more basic metal salts present in an amount to neutralize at greater than or equal to about 30 percent of the acid groups of Component (B), and any and all combinations thereof.

In another aspect the golf ball is a six-piece ball with a unitary core and the one or more of the four mantle layers comprises the Li-catalyzed polybutadiene/polyalkenamer blend material and the outer cover layer comprises a block copolymer, an acidic polymer, a unimodal ionomer, a bimodal ionomer, a modified unimodal ionomer, a modified bimodal ionomer, a polyalkenamer, a polyamide, a thermoplastic or thermoset polyurethane or thermoplastic or thermoset polyurea, or a multicomponent blend composition (“MCBC”), the MCBC comprising (A) a block copolymer; and (B) one or more acidic polymers; and (C) one or more basic metal salts present in an amount to neutralize at greater than or equal to about 30 percent of the acid groups of Component (B), and any and all combinations thereof.

The one or more intermediate layers of the golf balls may have a thickness of from about 0.010 to about 0.400, preferably from about 0.020 to about 0.200 and most preferably from about 0.030 to about 0.100 inches.

The one or more intermediate layers of the golf balls may also have a Shore D hardness as measured on the ball of greater than about 25, preferably greater than about 40, and most preferably greater than about 50 Shore D units.

The outer cover layer of the balls may have a thickness of from about 0.015 to about 0.100, preferably from about 0.020 to about 0.080, more preferably from about 0.025 to about 0.060 inches.

The outer cover layer the balls may also have a Shore D hardness as measured on the ball of from about 30 to about 75, preferably from 38 to about 68 and most preferably from about 40 to about 65.

The core of the balls also may have a PGA compression of less than about 140, preferably less than about 100, and most preferably less than about 90.

The various core layers (including the center) if present may each exhibit a different hardness. The difference between the center hardness and that of the next adjacent layer, as well as the difference in hardness between the various core layers may be greater than 2, preferably greater than 5, most preferably greater than 10 units of Shore D.

In one preferred aspect, the hardness of the center and each sequential layer increases progressively outwards from the center to outer core layer.

In another preferred aspect, the hardness of the center and each sequential layer decreases progressively inwards from the outer core layer to the center.

The core of the balls may have a diameter of from about 0.5 to about 1.62, preferably from about 0.7 to about 1.60, more preferably from about 0.9 to about 1.58, yet more preferably from about 1.20 to about 1.54, and even more preferably from about 1.40 to about 1.50 in.

More specifically, for a three piece golf ball consisting of a core, a mantle, and a cover, the diameter of the core is most preferably greater than or equal to 1.41 inches in diameter.

More specifically, for a four piece golf ball (consisting of a core, an inner mantle, an outer mantle, and a cover wherein the inner mantle is encased by an outer mantle) the diameter of the core is most preferably greater than or equal to 1.00 inches in diameter.

More specifically, for a five piece golf ball (consisting of an inner core, an outer core, an inner mantle, an outer mantle, and a cover wherein the inner core and inner mantle are encased by outer core and outer mantle, respectively) the diameter of the core is most preferably greater than or equal to 1.00 inches in diameter.

More specifically, for a six piece golf ball (consisting of an inner core, an intermediate core, an outer core, an inner mantle, an outer mantle, and a cover wherein the intermediate core and inner mantle are encased by outer core and outer mantle, respectively) the diameter of the core is most preferably greater than or equal to 1.00 inches in diameter.

More specifically, for a six piece golf ball (consisting of an inner core, an outer core, an inner mantle, an intermediate mantle, an outer mantle, and a cover wherein the intermediate core and inner mantle are encased by outer core and outer mantle, respectively) the diameter of the core is most preferably greater than or equal to 1.00 inches in diameter.

The COR of the golf balls may be greater than about 0.700, preferably greater than about 0.730, more preferably greater than 0.750, most preferably greater than 0.775, and especially greater than 0.800 at 125 ft/sec inbound velocity.

The shear cut resistance of the golf balls of the present invention is less than about 4, preferably less than about 3, even more preferably less than about 2.

These and other aspects of the present invention may be more fully understood by reference to the following examples. While these examples are meant to be illustrative of golf balls and golf ball components made according to the present invention, the present invention is not meant to be limited by the following examples.

### Examples

The various test properties which may be used to measure the properties of the golf balls of the present invention are described below including any test methods as defined below.

Core or ball diameter may be determined by using standard linear calipers or size gauge.

Compression may be measured by applying a spring-loaded force to the golf ball center, golf ball core, or the golf ball to be examined, with a manual instrument (an “Atti gauge”) manufactured by the Atti Engineering Company of Union City, N.J. This machine, equipped with a Federal Dial Gauge, Model D81-C, employs a calibrated spring under a known load. The sphere to be tested is forced a distance of 0.2 inch (5 mm) against this spring. If the spring, in turn, compresses 0.2 inch, the compression is rated at 100; if the spring compresses 0.1 inch, the compression value is rated as 0. Thus more compressible, softer materials will have lower Atti gauge values than harder, less compressible materials. Compression measured with this instrument is also referred to as PGA compression. The approximate relationship that exists between Atti or PGA compression and Riehle compression can be expressed as:

(Atti or PGA compression)=(160-Riehle Compression).

Thus, a Riehle compression of 100 would be the same as an Atti compression of 60.

COR may be measured using a golf ball or golf ball subassembly, air cannon, and a stationary steel plate. The steel plate provides an impact surface weighing about 100 pounds or about 45 kilograms A pair of ballistic light screens, which measure ball velocity, are spaced apart and located between the air cannon and the steel plate. The ball is fired from the air cannon toward the steel plate over a range of test velocities from 50 ft/s to 180 ft/sec (for the tests used herein the velocity was 125 ft/sec). As the ball travels toward the steel plate, it activates each light screen so that the time at each light screen is measured. This provides an incoming time period proportional to the ball's incoming velocity. The ball impacts the steel plate and rebounds though the light screens, which again measure the time period required to transit between the light screens. This provides an outgoing transit time period proportional to the ball's outgoing velocity. The coefficient of restitution can be calculated by the ratio of the outgoing transit time period to the incoming transit time period, COR=T_{Out}/Tᵢₙ.

A “Mooney” viscosity is a unit used to measure the plasticity of raw or unvulcanized rubber. The plasticity in a Mooney unit is equal to the torque, measured on an arbitrary scale, on a disk in a vessel that contains rubber at a temperature of 100° C. and rotates at two revolutions per minute. The measurement of Mooney viscosity is defined according to ASTM D-1646.

Shore D hardness may be measured in accordance with ASTM Test D2240.

Melt flow index (MFI, 12) may be measured in accordance with ASTM D-1238, Condition 230° C./2.16 kg.

Tensile Strength and Tensile Elongation were measured with ASTM D-638.

Flexural modulus and flexural strength were measured using ASTM standard D-790.

Shear cut resistance may be determined by examining the balls after they were impacted by a pitching wedge at controlled speed, classifying each numerically from 1 (excellent) to 5 (poor), and averaging the results for a given ball type. Three samples of each Example may be used for this testing. Each ball is hit twice, to collect two impact data points per ball. Then, each ball is assigned two numerical scores—one for each impact—from 1 (no visible damage) to 5 (substantial material displaced). These scores may be then averaged for each Example to produce the shear resistance numbers. These numbers may be then directly compared with the corresponding number for a commercially available ball, having a similar construction including the same core and mantle composition and cover thickness for comparison purposes.

Impact durability may be tested with an endurance test machine. The endurance test machine is designed to impart repetitive deformation to a golf ball similar to a driver impact. The test machine consists of an arm and impact plate or club face that both rotate to a speed that generates ball speeds of approximately 155-160 mph. Ball speed is measured with two light sensors located 15.5″ from impact location and are 11″ apart. The ball is stopped by a net and if a test sample is not cracked will continue to cycle through the machine for additional impacts. For golf balls, if zero failures occur through in excess of 100 impacts per ball than minimal field failures will occur. For layers adjacent to the outer cover, fewer impacts are required since the cover typically “protects” the inner components of the golf ball.

Golf ball Sound Pressure Level, S, in decibels (dB) and Frequency in hertz (Hz) may be measured by dropping the ball from a height of 113 in onto a marble (“starnet crystal pink”) stage of at least 12″ square and 4.25 inches in thickness. The sound of the resulting impact is captured by a microphone positioned at a fixed proximity of 12 inches, and at an angle of 30 degrees from horizontal, from the impact position and resolved by software transformation into an intensity in db and a frequency in Hz. Data collection is done as follows:

Microphone data is collected using a laptop PC with a sound card. An A-weighting filter is applied to the analog signal from the microphone. This signal is then digitally sampled at 44.1 KHz by the laptop data acquisition system for further processing and analysis. Data Analysis was done as follows:

The data analysis is split into two processes:

a. Time series analysis that generates the root mean square (rms) sound pressure level (SPL) for each ball impact sound.
i. An rms SPL from a reference calibration signal is generated in the same manner as the ball data.
ii. The overall SPL (in decibels) is calculated from the reference signal for each ball impact sound.
iii. The median SPL is recorded based on 3 impact tests.

b. Spectral analyses for each ball impact sound
i. Fourier and Autoregressive spectral estimation techniques are employed to create power spectra.
ii. The frequencies (in cycles/sec-Hz) from highest level peaks representing the most active sound producing vibration modes of each ball are identified.

The molecular weight (Mw) and Mw/Mn values for the PHPB compositions were determined by Gel Permeation Chromatography.

Test results for 3 inventive golf ball examples (15KNIM 55D, 25KNIM 55D, and 25KNIM 60D) and one comparative golf ball example (JNIM 55D) are shown in Tables 1 and 2 below. LiBr 710S is a lithium-catalyzed polybutadiene commercially available from Kumho Rubber. ZDA12 is zinc diacrylate. ZnPCTP is zinc pentachlorothiophenol. ZMBT is zinc 2-mercaptobenzothiazole. Varox 231XL and Varox 130XL are peroxides.

TABLE 1

| | Comparative | | | |
|---|---|---|---|---|
| | Example 1 | Example 2 | Example 3 | Example 4 |
| | JNIM | 15KNIM | 25KNIM | 25KNIM |
| | 55D | 55D | 55D | 60D |
| Material | | | | |
| Vestenamer 8012 | 100.0 | 85.0 | 75.0 | 75.0 |
| LiBr 710S | | 15.0 | 25.0 | 25.0 |
| ZDA12 | 55.0 | 55.0 | 55.0 | 60.0 |
| ZnO Aktiv | 5.0 | 5.0 | 5.0 | 5.00 |
| ZnPCTP | 2.00 | 2.00 | 2.00 | 2.00 |
| ZMBT | 3.00 | 3.00 | 3.00 | 3.00 |
| Varox 231XL | 0.75 | 0.75 | 0.75 | 0.75 |
| Varox 130XL | 0.14 | 0.14 | 0.14 | 0.14 |
| Sphere Physicals | | | | |
| Pole Size | 1.471 | 1.477 | 1.478 | 1.474 |
| Equator Size | 1.472 | 1.474 | 1.475 | 1.472 |
| Weight (grams) | 30.353 | 30.655 | 30.787 | 30.971 |
| Compression | 107 | 109 | 114 | 124 |
| C.O.R. | 0.802 | 0.801 | 0.802 | 0.807 |
| Shore D Hardness | 53.1 | 54.6 | 56.1 | 59.0 |
| (1-sec) | | | | |
| Specific Gravity | 1.11 | 1.11 | 1.11 | 1.13 |

TABLE 2

| | Comparative | | |
|---|---|---|---|
| | Example 1 | Example 3 | Example 4 |
| | A | B | C |
| Preferred Specs | | | |
| Core Size | 1.260 | 1.260 | 1.260 |
| Core Compression | 25 | 25 | 25 |
| SpG/Weight | 1.280/22 g | 1.280/22 g | 1.280/22 g |
| Inner Mantle | NIM 55D | 25 KNIM55D | 25 KNIM60D |
| Mat'l SpG | 1.090 | 1.120 | 1.130 |
| Diameter(in) | 1.380 | 1.380 | 1.380 |
| Thickness(in) | 0.060 | 0.060 | 0.060 |
| Target Wt(g) | 27.9 g | 27.9 g | 27.9 g |
| Intermediate Mantle | HPF1000 | HPF1000 | HPF1000 |
| Mat'l SpG | 0.960 | 0.960 | 0.960 |
| Diameter(in) | 1.500 | 1.500 | 1.500 |
| Thickness(in) | 0.060 | 0.060 | 0.060 |
| Target Wt(g) | 34.1 g | 34.1 g | 34.1 g |
| Outer Mantle | 50% 8150 | 50% 8150 | 50% 8150 |
| | 50% 9150 | 50% 9150 | 50% 9150 |
| Mat'l SpG | 0.97 | 0.97 | 0.97 |
| Diameter(in) | 1.620 | 1.620 | 1.620 |
| Thickness(in) | 0.060 | 0.060 | 0.060 |
| Target Wt(g) | 41.4 g | 41.4 g | 41.4 g |
| Cover | | | |
| Mat'l SpG | 1.11 | 1.11 | 1.11 |
| Thickness(in) | 0.030 | 0.030 | 0.030 |
| Inner Mantle | | | |
| Physicals | | | |
| Pole Size | 1.385 | 1.382 | 1.379 |
| Compression (PGA) | 35 | 40 | 41 |
| Weight (g) | 28.130 | 28.107 | 27.974 |
| Hardness (D/JIS-C) | 49.2 | 49.9 | 54.3 |
| COR (125fps) | 0.748 | 0.746 | 0.753 |
| Durability Results | No Break | No Break | No Break |
| (100 hits) | | | |
| Outer Mantle | | | |
| Physicals | | | |
| Pole Size | 1.620 | 1.619 | 1.619 |
| Compression (PGA) | 87 | 89 | 91 |
| Weight (g) | 41.346 | 41.397 | 41.323 |
| Hardness (D/JIS-C) | 69.5 | 70.2 | 70.1 |
| COR (125fps) | 0.806 | 0.803 | 0.807 |
| Ball Physicals | | | |
| Pole Size | 1.681 | 1.682 | 1.682 |
| Equator Size | 1.681 | 1.682 | 1.682 |
| Compression (PGA) | 89 | 90 | 93 |
| Weight (g) | 45.598 | 45.720 | 45.709 |
| Hardness (D/JIS-C) | 57.4 | 57.1 | 57.0 |
| Durability Results | 125, 130, 134, | 125, 128, 130, | 115, 126, 146, |
| | 134, 141, 148 | 144, 145, 155 | 156, 157, 161 |
| Durability Average | 135 | 138 | 144 |
| COR (125fps) | 0.800 | 0.797 | 0.803 |
| 175 mph Driver Spin | 2833 | 2839 | 2811 |
| Launch | 12.2 | 12.0 | 12.1 |
| Speed | 174.2 | 174.2 | 174.8 |
| 5 Iron Spin | 5375 | 5418 | 5417 |
| Launch | 15.7 | 15.6 | 15.6 |
| Speed | 137.8 | 137.5 | 137.8 |
| 30 yd PW Spin | 6988 | 6998 | 7034 |
| Launch | 29.8 | 29.7 | 29.5 |
| Speed | 43.8 | 43.3 | 43.5 |

In certain embodiments, the golf balls of the present invention have a durability of at least 138.

In view of the many possible embodiments to which the principles of the disclosed invention may be applied, it should be recognized that the illustrated embodiments are only preferred examples of the invention and should not be taken as limiting the scope of the invention.

What is claimed is:

1. A golf ball comprising:
(a) a core;
(b) one or more mantle layers; and
(c) an outer cover layer, wherein
at least one of the mantle layers comprises a blend composition of a lithium-catalyzed polybutadiene rubber and a polyalkenamer.

2. The golf ball of claim 1, wherein the blend composition is a reaction product of (i) the lithium-catalyzed polybutadiene rubber, (ii) the polyalkenamer, and (iii) at least one crosslinking agent, co-crosslinking agent, peptizer, accelerator or a mixture thereof.

3. The golf ball of claim 1, wherein the blend composition is a reaction product resulting from a mixture comprising the lithium-catalyzed polybutadiene rubber, the polyalkenamer, and zinc diacrylate.

4. The golf ball of claim 1, wherein the lithium-catalyzed polybutadiene rubber contains from 20 to 70 mol percent trans 1,4-addition, from 20 to 50 mol percent cis 1,4-addition, and from 3 to 40 mol percent 1,2-vinyl content.

5. The golf ball of claim 1, wherein the double bonds of the lithium-catalyzed polybutadiene rubber are not hydrogenated.

6. The golf ball of claim 1, wherein the polyalkenamer is a polyoctenamer.

7. The golf ball of claim 1, wherein the Li-catalyzed polybutadiene is present in the blend composition in an amount of 2 to 50 weight %, and the polyalkenamer is present in the blend composition in an amount of 50 to 98 weight %, based on the total weight of the Li-catalyzed polybutadiene combined with the polyalkenamer.

8. The golf ball of claim 2, wherein the lithium-catalyzed polybutadiene rubber contains from 20 to 70 mol percent trans 1,4-addition, from 20 to 50 mol percent cis 1,4-addition, and from 3 to 40 mol percent 1,2-vinyl content; the double bonds of the lithium-catalyzed polybutadiene rubber are not hydrogenated; and the polyalkenamer is a polyoctenamer.

9. The golf ball of claim 3, wherein the lithium-catalyzed polybutadiene rubber contains from 20 to 70 mol percent trans 1,4-addition, from 20 to 50 mol percent cis 1,4-addition, and from 3 to 40 mol percent 1,2-vinyl content; the double bonds of the lithium-catalyzed polybutadiene rubber are not hydrogenated; and the polyalkenamer is a polyoctenamer.

10. The golf ball of claim 7, wherein the lithium-catalyzed polybutadiene rubber contains from 20 to 70 mol percent trans 1,4-addition, from 20 to 50 mol percent cis 1,4-addition, and from 3 to 40 mol percent 1,2-vinyl content; the double bonds of the lithium-catalyzed polybutadiene rubber are not hydrogenated; and the polyalkenamer is a polyoctenamer.

11. The golf ball of claim 1, wherein the blend composition constitutes greater than 90 weight % of the total weight of the material forming the mantle layer.

12. The golf ball of claim 1, wherein the golf ball is a three-piece golf ball.

13. The golf ball of claim 1, wherein the golf ball is a four-piece golf ball.

14. The golf ball of claim 1, wherein the golf ball has a durability of at least 138.
